(19) United States
(12) Patent Application Publication
(10) Pub. No.: US 2006/0153482 A1
(43) Pub. Date: Jul. 13, 2006

(54) Wheel support bearing assembly with built-in load sensor

(75) Inventors: Takashi Koike, Iwata-shi (JP); Tomomi Ishikawa, Iwata-shi (JP)

Correspondence Address: OSHA LIANG L.L.P., 1221 MCKINNEY STREET, SUITE 2800, HOUSTON, TX, 77010, US

(73) Assignee: NTN Corporation, Osaka (JP)

(21) Appl. No.: 11/357,243

(22) Filed: Feb. 17, 2006

Related U.S. Application Data
(63) Continuation-in-part of application No. 10/563,281.

(30) Foreign Application Priority Data
Apr. 7, 2003 (JP) 2003-192223

(51) Int. Cl. F16C 41/04

(52) U.S. Cl. 384/448

(57) ABSTRACT

A sensor-incorporated wheel support bearing assembly includes a stationary outer member having a plurality of raceway grooves defined in an inner peripheral surface thereof, an inner member made up of a rotatable hub axle and an inner race segment mounted on an inboard end portion of the hub axle with a vehicle wheel being supported by the hub axle. The inner member has a corresponding number of raceway grooves defined in the hub axle and the inner race segment, respectively. Rows of rolling elements are interposed between the outer member 1 and the inner member. A to-be-detected member in the form of a magnetostrictive element is formed in a portion of the outer periphery of the hub axle adjacent an inboard side and remote from the raceway groove. At least one force detecting unit for detecting a change in magnetic strain induced in the to-be-detected member is provided in an outer race, which is a non-rotatable member, for detecting a force acting on a shaft coupled with the inner member.

### CROSS-REFERENCE TO THE RELATED APPLICATIONS

This application is a continuation-in-part of U.S. application Ser. No. 10/563,281 filed on Jan. 4, 2006, entitled “Wheel Support Bearing Assembly With Built-in Load Sensor.”

### BACKGROUND OF THE INVENTION

1. Field of the Invention

The present invention relates to a wheel support bearing assembly having a load sensor built therein for detecting a load imposed on a bearing unit of a vehicle wheel.

2. Description of the Conventional Art

The sensor-incorporated wheel support bearing assembly has hitherto been well known, which is provided with a sensor for detecting the rotational speed or number of revolutions of a vehicle wheel for the purpose of securing the running safety of an automotive vehicle. It has been suggested in, for example, the Japanese Laid-open Patent Publication No. 2002-340922 that this type of wheel support bearing assembly makes additional use of various sensors including, for example, a temperature sensor and a vibration sensor so that other parameters useful for controlling the run of the automotive vehicle than the rotational speed of the vehicle wheel can be detected together with the rotational speed.

The measures for assuring the running safety of the automotive vehicle hitherto generally employed is practiced by detecting the rotational speed of each of vehicle wheels. It is, however, been found that the detection of only the rotational speed is insufficient and, therefore, it is increasingly desired that the control on the safety side can be achieved with any additional sensor signals. To meet this desire, it may be contemplated to utilize information on a load, imposed on each of the vehicle wheels during the run of the automotive vehicle, to control the attitude of the automotive vehicle. As is well known to those skilled in the art, a load does not always act on the vehicle wheels uniformly at all times during the run of the automotive vehicles. By way of example, during cornering of the automotive vehicle, a large load acts on outer vehicle wheels; during running on a leftward or rightward tilted surface, a large load acts on vehicle wheels on one side of the automotive vehicle; and during braking, a large load acts on front vehicle wheels. Also, uneven distribution of payloads leads to uneven loads acting on each vehicle wheels.

In view of the above, if loads acting on the vehicle wheels can be detected whenever necessary, the vehicle suspension system can be controlled in advance based on results of detection of those loads so that control of the attitude of the automotive vehicle such as, for example, prevention of the rolling during the cornering, prevention of the nose dive during the braking, prevention of lowering of the level of the automotive vehicle resulting from uneven distribution of payloads and so on can be accomplished. However, there is no space available for installation of load sensors for detecting respective loads acting on the vehicle wheels and, therefore, the attitude control through the detection of the loads is considered difficult to achieve.

In the meantime, the steer-by-wire system, in which a wheel axle has no mechanical connection with a steering, has recently come to be introduced in automotive vehicles. With the increased use of the steer-by-wire system, the necessity of transmitting information on road surfaces to a steering wheel, then being maneuvered by the vehicle driver, through the detection of a load acting in a direction axially of a wheel axle will increase.

### SUMMARY OF THE INVENTION

In view of the foregoing, the present invention has been developed with a view to resolving the foregoing problems and is intended to provide a wheel support bearing assembly having a load sensor built therein for detecting the load acting on the vehicle wheel, in which the load sensor can be snugly and neatly installed on an automotive vehicle.

In order to accomplish the foregoing object, the sensor-incorporated wheel support bearing assembly for rotatably supporting a vehicle wheel relative to a vehicle body structure according to one aspect of the present invention includes an outer member having a plurality of raceway grooves defined in an inner peripheral surface thereof, an inner member positioned inside the outer member with an annular bearing space defined between it and the outer member and having a corresponding number of raceway grooves defined therein in alignment with the respective raceway grooves in the outer member, plural rows of rolling elements interposed between the raceway grooves in the outer member and the raceway grooves in the inner member, sealing members for sealing opposite open ends of the annular bearing spaces between the outer and inner members, and a load sensor disposed within the annular bearing space for detecting change in magnetic strain (magnetostriction) to thereby detect a load acting on the bearing assembly.

According to this aspect of the present invention, since the load sensor for detecting the load acting on the bearing assembly through detection of change in magnetic strain is provided within the annular bearing space delimited between the outer and inner members, no space for installation of the load sensor is required outside the bearing assembly and, therefore, the load sensor is allowed to be snugly and neatly accommodated in the automotive vehicle for the detection of the load acting on the vehicle wheel.

In the present invention, the load sensor may include a to-be-detected member made up of a magnetostrictive element and disposed on the inner member, and a force detecting unit positioned in the outer member for detecting a change in magnetic strain occurring in the to-be-detected member. The to-be-detected member may be positioned, for example, substantially intermediate between the raceway grooves.

In such case, an annular bearing space available between the raceway grooves for the dual row of the rolling elements and interior spaces available in members can be effectively and efficiently utilized for accommodating the to-be-detected member and the force detecting unit. For this reason, the load sensor can be further compactly disposed within the wheel support bearing assembly.

In the present invention, the force detecting unit may be in a form of a coiled winding. The coil winding is wound around, for example, a yoke made of a magnetic material. This coil winding of the force detecting unit may be wound around a yoke so as to form a magnetic circuit in an axial direction.

The use of the coiled winding is effective to allow a change in magnetic strain occurring in the to-be-detected member in the form of the magnetostrictive element to be easily detected with a simplified structure. Also, the use of the force detecting unit including the coiled winding formed in coaxial relation with the to-be-detected member formed in the inner member is effective to detect the axially acting load on a vehicle wheel as well.

A surface of the yoke confronting the to-be-detected member may be arcuately curved. The use of the arcuately curved sectional shape is effective to keep a gap between the to-be-detected member and free ends of the yoke at a constant value over an entire surface of the yoke free ends and, therefore, superimposition of a rotation synchronized component on a detection signal from the force detecting unit, which results from variation of the gap, can be relieved advantageously.

The to-be-detected member may include a plurality of circumferentially extending axial grooves defined therein. The presence of the circumferentially extending axial grooves does advantageously allow the direction of the magnetic strain caused by the axial load to be concentrated in an axial direction to thereby increase the sensitivity.

The grooves referred to above may be inclined relative to the axial direction. If the grooves are so inclined, detection of the torque is possible.

Where a practical effect of the circumferentially extending grooves to increase the sensitivity is desired, each of the circumferentially extending grooves has a depth preferably equal to or greater than 0.1 mm.

Also, where those grooves are employed, a rotation detecting unit which utilizes the grooves to detect a rotation signal may be employed. When the grooves forming a part of the to-be-detected member are utilized for the detection of the load, the rotation can be detected with no need to separately employ any encoder. For this reason, while securing a high performance by which the detection of the load and the detection of the rotation can be accomplished, the wheel support bearing assembly can be compactized and increase of the assemblability resulting from reduction of the number of component parts used and simplification of the wiring system can also be accomplished, accompanied by reduction of the cost.

In the present invention, the to-be-detected member comprised of the magnetostrictive element may be a layer of an Fe—Al alloy formed on a surface region of the inner member. With the Fe—Al alloy member, the magnetostrictive characteristic of the to-be-detected member can be increased and, hence, the detecting accuracy of the load sensor can be increased. Also, if the to-be-detected member is a layer formed on the surface region of the inner member, there is no need to employ a separate to-be-detected member and the assembling process can therefore be simplified.

The to-be-detected member referred to above may be made up of a magnetostrictive element formed by shaping a clad steel, of which surface is an Fe—Al alloy, to represent a ring shape, in which case the ring shaped magnetostrictive element is fixed on an outer periphery of the inner member. If the ring shaped magnetostrictive element is fixed in this way, no formation of the alloyed layer, which eventually forms the to-be-detected member in the inner member, is necessary and the manufacture of the inner member can advantageously be simplified.

Where the to-be-detected member is employed in the form of the alloy layer formed on the surface region of the inner member, that axial portion of the inner member, where the to-be-detected member is provided, may have a rigidity reduced to a value lower than that of any other axial portion of the inner member. In such case, within the limit of rigidity required in the wheel support bearing assembly, the rigidity of a certain axial portion of the to-be-detected member may be lowered. By so doing, the strain occurring in the to-be-detected member can be increased, resulting in increase of the sensitivity.

the rigidity of the axial portion where the to-be-detected member is provided may be reduced by defining a thin-walled portion formed by recessing a portion of an inner peripheral surface of the inner member, that is positioned inwardly of the to-be-detected member, or a stepped portion formed by reducing an outer diameter of that axial portion, where the to-be-detected member is provided, down to a value smaller than that of other portions of that axial portion. In either case, processing can be easily accomplished because of reduction of the rigidity.

In the present invention, at least one of a surface of the to-be-detected member and a surface of a yoke of the force detecting unit which confronts the to-be-detected member may be machined or ground to form a mechanically processed surface for increasing a concentricity or roundness therebetween.

The output from the force detecting unit may be superimposed with a rotation synchronized component resulting from rotation of the inner member. However, if the precision of the concentricity or the roundness is increased in the manner as hereinabove described, influence which may be brought about by synchronization of rotation can advantageously be minimized.

In the present invention, the force detecting unit may include at least two force detecting elements and means may be provided for detecting the magnitude and direction of a force in reference to a detection signal output from each of the force detecting elements. Even in this case, the force detecting unit may be a coil. The use of the plural force detecting element allows not only the magnitude of the load, but also the direction of the load, for example, the bending direction to be detected in reference to the difference of detected values thereof.

In the case that the force detecting unit includes at least two force detecting elements, those force detecting elements may be spaced from each other in a vertical direction and the force detecting unit may further comprise a circuit for detecting a force caused by a bending moment and an axially acting force separately in reference to the direction signal outputted from each of the force detecting elements. The use of the at least two force detecting elements spaced from each other in a vertical direction is effective to allow the following detection to be accomplished. In the event that a bending moment acts on the vehicle wheel, a tensile force or a compressive force acts on the upper force detecting element held at an upper location above the inner member and, on the other hand, a compressive force or a tensile force acts on the lower force detecting element held at a lower location below the inner member, in a manner substantially reverse to that acting on the upper force detecting element. The magnetic reluctances of the force detecting elements in the form of a detecting coil or the like positioned upwardly and downwardly of the inner member, respectively, undergoes change in dependence on the magnitude of the tensile and compressive forces, with such change being indicative of change of the load acting on the vehicle wheel. In view of this, if the difference between the respective magnetic reluctances of the upper and lower force detecting elements is calculated, the bending load acting on the hub axle and the direction thereof can be detected.

If similar force detecting members each in the form of, for example, a detecting coil are added in a horizontal direction of the inner member, the horizontally acting bending load acting on the vehicle wheel and the direction thereof can be additionally detected. When the magnetic reluctances of the force detecting members each in the form of the detecting coil are summed together, the load acting in a direction axially of the shaft can also be detected. Thus, the force brought about by the bending moment acting on the vehicle wheel and the force acting in a direction axially of the shaft can be detected with high precision.

In the present invention, a torque detecting means may be provided for detecting a change in magnetic strain occurring in the to-be-detected member to thereby detect a torque. If the torque is detected, it is possible to convert it into the load acting on the vehicle wheel in a direction conforming to the running direction.

The torque detecting means referred to above may include a generally U-shaped exciting head for exciting the to-be-detected member, and a generally U-shaped detecting head for detecting a change in magnetic strain occurring in the to-be-detected member. In this case, the exciting and detecting heads are preferably arranged in a relation perpendicular to each other. The exciting head generates an alternating magnetic field whereas the detecting head operates to detect a change in alternately magnetized component when the torque acts on the surface of the shaft. Since the magnitude of the alternately magnetized component varies depending on the magnitude and orientation of the shearing stress in the 45° angled direction, the torque can be detected.

Other than the specific torque detecting means referred to above, the torque detecting means may be of a type capable of detecting the torque by detecting grooves which are formed in the to-be-detected member, comprised of the magnetostrictive element, so as to deploy in a circumferential direction and as to be inclined relative to an axial direction.

In the present invention, the force detecting unit may include a yoke made of a magnetic material and having a coil wound therearound, which coil of the force detecting unit is arranged in a portion of the outer member, confronting the to-be-detected member, in a coaxial relation with the force detecting unit while spaced a predetermined distance from the to-be-detected member and wherein a change in magnetic strain occurring as a result of an axial load in the to-be-detected member is detected by the coil over an entire circumference of the to-be-detected member.

Also, in the present invention, the sensor-incorporated wheel support bearing assembly may be provided with means for detecting a horizontally acting bending moment from a detection signal output from the force detecting unit, and means for detecting a load acting on the wheel support bearing assembly in a direction confronting a running direction, in reference to the horizontally acting bending moment and a center point of support of the wheel support bearing assembly.

In the present invention, the sensor-incorporated wheel support bearing assembly may also be provided with a signal processing means for rendering only a peak value of a load signal, obtained from the load sensor, to be a load signal.

The rotation synchronized component in the output from the load sensor brings about one or more cycles of sensor output change each time the inner member undergoes one complete rotation. The inner member generally rotates at a speed equal to the rotational speed of the vehicle wheel and the frequency of the synchronized component varies with the vehicle running speed, i.e., from a few Hz at a low running speed to some tens Hz at a high running speed. Since this frequency is low, it is not easy to remove the change even when the sensor signal is passed through a low pass filter. In view of this, if the peak value of the sensor output signal is detected and is used as a load signal, the synchronized component can be removed completely.

In the present invention, the sensor-incorporated wheel support bearing assembly may furthermore include means for canceling an offset of an output from the load sensor with an output from the load sensor during parking or straight run being taken as zero.

Where the coils are employed for the force detecting unit, it may occur that the output from the force detecting unit is offset direct-currently depending on the temperature and environment in which it is used. In such case, if as one of countermeasures, the offset of an output from the load sensor is cancelled with an output from the load sensor during parking or straight run being taken as zero, a highly accurate detection of the load is possible.

In the present invention, the wheel support bearing assembly may include electrodes disposed within the force detecting unit for drawing signals therefrom, and terminals for contacting or engaging the electrodes of the force detecting unit from outside of the outer member while the force detecting unit is fixedly mounted on the outer member. The use of the electrodes and the corresponding terminals is effective to facilitate assemblage.

In such case, the terminals to be inserted from outside of the outer member may be integrated with a connector casing and further comprising a waterproofing rubber bush interposed between the connector casing and the outer member. By so doing, not only can the waterproofing be achieved easily, but also the reliability can be increased advantageously.

In the present invention, the force detecting unit may be divided into a plurality of detecting members and those detecting members may be inserted from outside of the outer member and are then fixed in position. Even in this case, the assemblage can be simplified.

In the present invention, the wheel support bearing assembly may yet include means for utilizing a load signal obtained from the load sensor for an attitude control of the automotive body structure. Since the load signal obtained from the force detecting unit is a signal accurately reflecting a change in attitude of the automotive vehicle, the utilization of this load signal is effective to facilitate an attitude control of the vehicle body structure.

In the present invention, the wheel support bearing assembly may include means for detecting a condition of a road surface in reference to a frequency of the load signal output from the load sensor. For processing of the load sensor signal, it is possible to detect a condition of a road surface in reference to the frequency of the load signal or the amplitude of the load signal. Based on this signal, it is possible to use for the reaction control in the steer-by-wire system.

In the present invention, the wheel support bearing assembly may additionally include one or both of a rotation sensor and a temperature sensor. In such case, not only the load acting on a shaft, but also the rotational sped and the temperature can be detected from the wheel support bearing assembly and, therefore, a sophisticated vehicle attitude control or a generation of an abnormality warning can be achieved. Since those plural detecting functions are provided in the single bearing assembly, the space required for accommodating a plurality kinds of sensors can advantageously be minimized and the job of installing those sensors can also be simplified.

In the present invention, at least one of means for supplying an electric power to the load sensor and means for transmitting a detection signal from the load sensor operates wirelessly. By way of example, the use may be made of the transmitting means for transmitting wirelessly a force signal detected by the force detecting unit and, on the other hand, a receiving unit for supplying an electric power wirelessly may be provided in the sensor-incorporated wheel support bearing assembly. For wireless supply of the electric power, electromagnetic waves, for example, are employed.

The wireless supply of the electric power and wireless transmission of the detection signal are effective to dispense the use of any wiring between a battery or a control device, provided in the vehicle body structure for receiving a detected force signal, and the force detecting unit and, therefore, the wiring system can advantageously be simplified.

In the present invention, the inner member referred to above preferably includes a hub axle and an inner race segment mounted on an inboard end portion of the hub axle and the load sensor preferably includes a to-be-detected member in the form of a magnetostrictive element provided on a portion of an outer periphery of the hub axle adjacent the inboard end portion thereof and remote from the raceway groove and at least one force detecting unit for detecting change in magnetic strain of the to-be-detected member.

According to these structural features, the magnetostrictive characteristic of the magnetostrictive element, which forms the to-be-detected member, varies in dependence on change of the load acting on a shaft coupled with the inner member and the force detecting unit detects such change in magnetic strain to eventually detect the load acting on the vehicle wheel. Since the to-be-detected member suffices to be formed on that portion of the outer periphery of the hub axle adjacent the inboard end portion thereof and, on the other hand, the force detecting unit suffices to be disposed inside the bearing assembly in face-to-face relation with the to-be-detected member, no space for installation of the sensor is required outside the bearing assembly, allowing the load sensor to be snugly and neatly accommodated in the automotive vehicle.

In the case of this construction, the cylindrical mounting region of the hub axle, where the inner race segment is mounted, may be undersized in diameter relative to the raceway groove and be extended a distance towards an outboard side beyond an axial region where the inner race segment is seated, in which case a ring-shaped magnetostrictive member is press-fitted onto that portion of the cylindrical mounting region of the hub axle.

Where the magnetostrictive material which is an independent member is employed as described above, the to-be-detected member need not be formed directly in the hub axle nor the inner race segment and, therefore, machining of the hub axle and the inner race segment one at a time can advantageously be facilitated. Also, since the magnetostrictive member is mounted on that portion of the cylindrical mounting region of the hub axle which has been extended axially, not only can the magnetostrictive member be easily assembled in the bearing assembly, but also no special processing is required to mount the magnetostrictive member onto the hub axle, facilitating the assemblage of the hub axle in the bearing assembly.

In the present invention, the inner member is made up of a hub axle and an inner race segment mounted on an inboard end portion of the hub axle, rows of rolling elements interposed between the raceway grooves in the outer member and the raceway grooves in the inner member, respectively, and a load sensor including a to-be-detected member in the form of a magnetostrictive element provided on a portion of an outer periphery of the hub axle between an outboard end portion of the inner race segment and the raceway groove and at least one force detecting unit provided in the outer member for detecting change in magnetic strain of the to-be-detected member.

According to this construction, where the to-be-detected member is provided in the inner race segment, the processing can be simplified since during the process of forming the to-be-detected member the inner race segment is relatively small as compared with the hub axle. It is, however, to be noted that where sealing members are employed to seal off opposite ends of both of the outer and inner members, the to-be-detected member referred to above may be disposed either within the space formed by sealing the opposite ends by the respective sealing members or outside this sealed space.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a fragmentary longitudinal sectional view of a wheel support bearing assembly having a load sensor built therein in accordance with a first preferred embodiment of the present invention, showing the structure for rotatably supporting a vehicle drive wheel;

FIG. 2 is a fragmentary longitudinal sectional view, on an enlarged scale, showing the wheel support bearing assembly with a load sensor built therein;

FIG. 3 is a fragmentary sectional view showing, on an enlarged scale, a to-be-detected member employed in the wheel support bearing assembly having the load sensor built therein;

FIG. 4A is a cross-sectional view taken along the line IV-IV in FIG. 3;

FIG. 4B is a cross-sectional view taken along the line IV-IV in FIG. 3, showing a modified form of the to-be-detected member;

FIG. 5A is a sectional view showing four coiled windings disposed in face-to-face relation with the to-be-detected member;

FIG. 5B is a sectional view showing four coiled windings disposed in face-to-face relation with the to-be-detected member;

FIG. 6A is a sectional view showing force detecting elements;

FIG. 6B is a fragmentary sectional view showing one of the force detecting elements;

FIG. 7 is a block circuit diagram showing an electric processing circuit;

FIG. 8 is a block circuit diagram showing a modified form of the electric processing circuit;

FIG. 9 is a longitudinal sectional view of the wheel support bearing assembly having the load sensor built therein in accordance with a second preferred embodiment of the present invention;

FIG. 10 is a longitudinal sectional view of the wheel support bearing assembly having the load sensor built therein in accordance with a third preferred embodiment of the present invention;

FIG. 11A is a sectional view showing modified forms of the coiled windings that form respective parts of the force detecting unit disposed in face-to-face relation with the to-be-detected member;

FIGS. 11B and 11C are cross-sectional views taken along the line Y-Y in FIG. 11A, showing different specifications of each of the coiled windings, respectively;

FIG. 12 is a sectional view showing the force detecting unit shown in FIG. 11A;

FIG. 13A is a longitudinal sectional view of the wheel support bearing assembly having the load sensor built therein in accordance with a fourth preferred embodiment of the present invention;

FIGS. 13B and 13C are fragmentary sectional views of a portion of the to-be-detected member employed in the wheel support bearing assembly, showing different examples thereof, respectively;

FIG. 14 is an explanatory diagram showing the waveform of an exemplary output from the sensor and an electric circuit for detecting such output from the sensor;

FIG. 15 is a sectional view showing an example in which the load detecting unit is provided with a rotation detecting unit;

FIG. 16 is a sectional view, on an enlarged scale, of a portion of the rotation force detecting unit shown in FIG. 15;

FIG. 17 is a circuit diagram showing a processing circuit for processing a detection signal output from the rotation detecting unit, shown together with waveforms of signals appearing at point A and B in the processing circuit;

FIG. 18 is a sectional view showing a further modification of the to-be-detected member and a detecting member in accordance with a fifth preferred embodiment;

FIG. 19 is a sectional view showing a still further modification of the to-be-detected member and a detecting member in accordance with a sixth preferred embodiment;

FIG. 20 is a circuit block diagram showing the processing circuit;

FIG. 21 is an explanatory diagram showing the relation between a vehicle wheel tire and the wheel support bearing assembly, which may be used in calculating the load acting in a direction conforming to the direction of run of the automotive vehicle;

FIG. 22 is a sectional view showing a still further modification of the to-be-detected member and the detecting member in accordance with a seventh preferred embodiment;

FIGS. 23A and 23B are fragmentary longitudinal sectional views showing different wheel support bearing assemblies according to fifth and sixth preferred embodiments of the present invention, respectively;

FIGS. 24A and 24B are sectional views showing different examples of wiring connection in the detecting member, respectively;

FIG. 25 is a sectional view showing the manner in which the split detecting members are assembled onto the outer member;

FIG. 26 is an explanatory diagram showing a conceptual construction of wireless transmission of an electric power to the force detecting unit and that of a detection signal from the force detecting unit and, also, a processing means for processing the detection signal; and

FIG. 27 is a schematic perspective view showing an example of the manner in which the torque is detected.

### DETAILED DESCRIPTION OF THE EMBODIMENTS

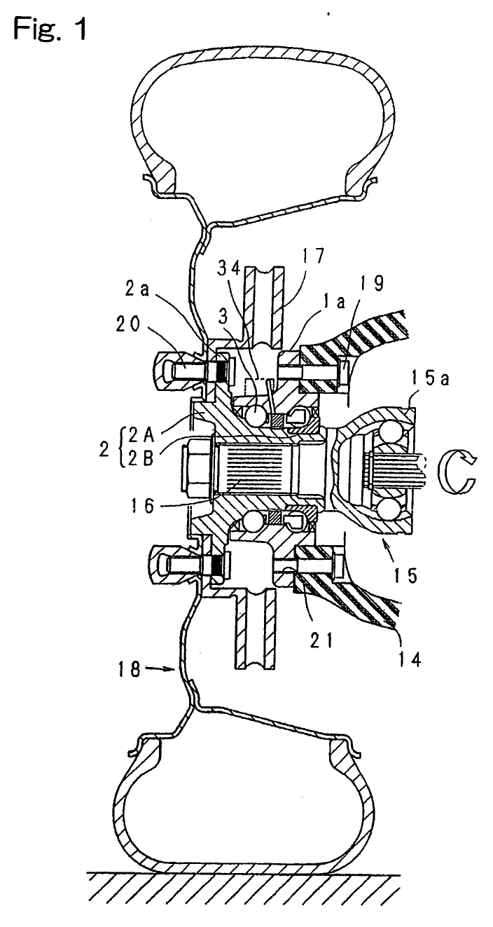

A wheel support bearing assembly having a load sensor built therein according to a first preferred embodiment of the present invention will now be described with particular reference to FIGS. 1 to 8. The wheel support bearing assembly according to this first embodiment represents a third generation model of an inner race rotating type and is so designed and so configured as to rotatably support a vehicle drive wheel.

Before describing some preferred embodiments of the present invention, it is to be noted that in the description made hereinbefore and hereinafter, the terms “inboard” and “outboard” are to be understood as representing outward and inward sides of an automotive vehicle in a lateral direction with respect to the longitudinal axis of the automotive vehicle, respectively. For example, in FIG. 1, a left side and a right side represent the outboard side and the inboard side, respectively.

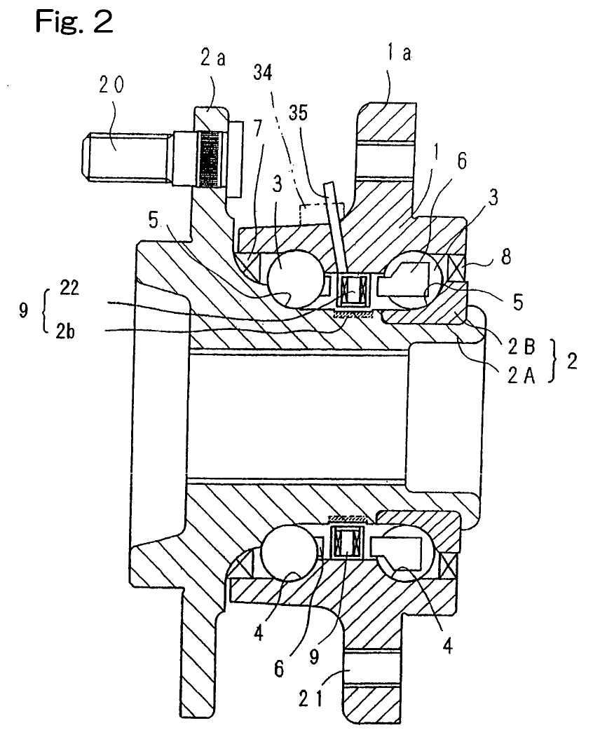

Referring first to FIG. 2, the wheel support bearing assembly shown therein includes an generally tubular outer member 1 having an inner peripheral surface formed with a plurality of, for example, two, raceway grooves 4, a generally tubular inner member 2 having an outer peripheral surface formed with raceway grooves 5 in alignment with the respective raceway grooves 4 and positioned inside the outer member 1 with an annular bearing space delimited between it and the outer member 1, and dual rows of rolling elements 3 rollingly interposed between the raceway grooves 4 in the outer member 1 and the raceway grooves 5 in the inner member 2. The illustrated wheel support bearing assembly is a dual row angular contact ball bearing, in which the raceway grooves 4 and 5 represent a generally arcuate sectional shape and are formed with their contact angles held in back-to-back relation with each other. The rolling element 3 of each row are in the form of a ball and are retained by a ball retainer 6.

The outer member 1 serves as a stationary or non-rotatable member and has a vehicle body fitting flange 1a formed integrally therewith so as to extend radially outwardly therefrom. The vehicle body fitting flange 1a is fastened to a knuckle 14, mounted rigidly on a vehicle chassis or body structure (not shown) by means of a plurality of circumferentially spaced bolts 19. Specifically, the vehicle body fitting flange 1a has internally threaded bolt insertion holes 21, into which the corresponding bolts 19 having passed through throughholes defined in the knuckle 14 are firmly threaded to thereby firmly connect the outer member 1 to the knuckle 14. It is, however, to be noted that, instead of the bolt insertion holes 21 being internally threaded, the bolt insertion holes 21 may be mere throughholes for receiving the corresponding bolts 19 so that the bolts 19 after having passed through the throughholes in the knuckle 14 and the vehicle body fitting flange 1a can be fastened with respective nuts (not shown).

The inner member 2 serves as a rotatable member and is made up of a hub axle 2A having a wheel mounting flange 2a formed integrally therewith so as to extend radially outwardly therefrom and a separate inner race segment 2B fixedly mounted on an inboard end of the hub axle 2A. The raceway grooves 5 shown and described as defined in the inner member 2 are in practice formed in an outer peripheral surface of the hub axle 2A and an outer peripheral surface of the inner race segment 2B, respectively.

As best shown in FIG. 1, the hub axle 2A has an axial bore defined therein and is coupled with a constant velocity universal joint 15, with an outer race 15a of the joint 15 inserted into the axial bore, for rotation together therewith. More specifically, the outer race 15a of the constant velocity universal joint 15 is formed integrally with a stub axle 16, which is inserted through the axial bore of the hub axle 2A and is then fastened with a nut to thereby connect the hub axle 2A firmly with the outer race 15 of the constant velocity universal joint 15. In order to secure the hub axle 2A on the stub axle 16 of the joint outer race 15a, axial grooves or splines are cut all around the stub axle 16 with matching grooves in the hub axle 2A to thereby allow the hub axle 2A and, hence, the inner member 2, and the joint outer race 15a to rotate together with each other.

The wheel mounting flange 2a is located at an outboard end of the inner member 2 and a vehicle wheel 18 is secured to the wheel mounting flange 2a by means of a plurality of bolts 20 with a brake rotor 17 intervening between the wheel mounting flange 2a and the vehicle wheel 18 as best shown in FIG. 1. The inner race segment 2B forming a part of the inner member 2 is mounted on the inboard end of the hub axle 2A and is fixedly held in position on the inboard end of the hub axle 2A by means of an inboard extremity of the hub axle 2A which has been crimped or staked radially outwardly.

The annular bearing space delimited between the outer member 1 and the inner member 2 has its opposite outboard and inboard open ends sealed by respective contact-type sealing members 7 and 8 as best shown in FIG. 2, which members 7 and 8 form respective sealing elements.

As shown in FIG. 2, the annular bearing space delimited between the outer member 1 and the inner member 2 accommodates therein a load sensor 9 that is positioned substantially intermediate between the outboard raceway grooves 4 and 5 and the inboard raceway grooves 4 and 5, i.e., between the outboard and inboard rows of the rolling elements 3. This load sensor 9 is made up of a to-be-detected member 2b and at least one force detecting unit 22 for detecting change in magnetic strain of the to-be-detected member 2b.

The to-be-detected member 2b includes a magnetostrictive element 2b formed in a cylindrical surface area of the outer peripheral surface of the inner member 2, particularly that of the hub axle 2A, bound between the raceway grooves 5 and 5 and on an inboard side of the raceway groove 5 defined in the hub axle 2A, by means of a process of imparting a magnetostrictive characteristic. While structural steel such as, for example, carbon steel is generally employed as a material for the hub axle 2A, an Fe—Al alloy is formed in at least the cylindrical surface area of the outer peripheral surface of the hub axle 2A by diffusing aluminum (Al) thereinto so that that cylindrical surface area of the outer peripheral surface of the hub axle 2A can exhibit an enhanced magnetostrictive characteristic. The to-be-detected member 2b can be readily available when that cylindrical surface area of the outer peripheral surface of the hub axle 2A is alloyed by diffusion of aluminum to form the Fe—Al alloy. However, this to-be-detected member 2b may also be available when after the entire outer peripheral surface of the hub axle 2A has been alloyed to form the Fe—Al alloy, an unnecessary portion of the entire outer peripheral surface of the hub axle 2A is ground to remove a portion of the Fe—Al alloy formed in that unnecessary portion.

As a method of diffusing aluminum into a metallic surface, the diffusion can be carried out by heating a closed vessel, containing the hub axle 2A and an aluminum powder, to a temperature of about 900° C. The depth of penetration of aluminum can be adjusted depending on the method used and the length of time during which the diffusion is effected, but is processed to be within the range of a few tens to 100 μm. The aluminum diffusion is carried out in such a manner that the concentration of aluminum in the structural steel, which forms a matrix of the hub axle 2A, may gradually decrease as the depth increases. Therefore, without the mechanical strength of the hub axle 2A being lowered, the Fe—Al alloy in the magnetostrictive diffusion layer having a high magnetostrictive characteristic can be obtained.

Specifically, when the aluminum is diffused from a surface of that cylindrical surface area of the hub axle 2A under the high temperature atmosphere so that the aluminum may be distributed from the surface thereof in a gradient concentration, it is possible to form in the steel material, which forms a matrix of the hub axle 2A, an aluminum diffusion layer in which the concentration of aluminum so diffused represents a gradient gently decreasing in a direction radially inwardly from the outer peripheral surface of the hub axle 2A. The diffusion layer having such a gradient concentration of aluminum is formed in a homogeneous alloy layer without pores such as found with an overlay spray coating and the occurrence of an early cracking, which would otherwise result from fatigue, can be suppressed considerably. Also, no cracking occurs even during the heat treatment.

If it is a magnetostrictive material prepared from a bulk material of Fe—Al alloy, it is so fragile that the processability may be lowered. However, according to the above described diffusion treatment, it has a processability similar to that exhibited by the standard steel material and the productivity can be considerably increased when the aluminum diffusion is carried out after completion of a mechanical processing of the hub axle 2A. For this reason, a low cost can be achieved.

The surface region including the raceway groove 5 and the cylindrical surface area (to-be-detected member) 2b of the hub axle 2A, which has been processed to form the Fe—Al alloy, may subjecte to a hardening treatment followed by a shot peening to increase the residue stress.

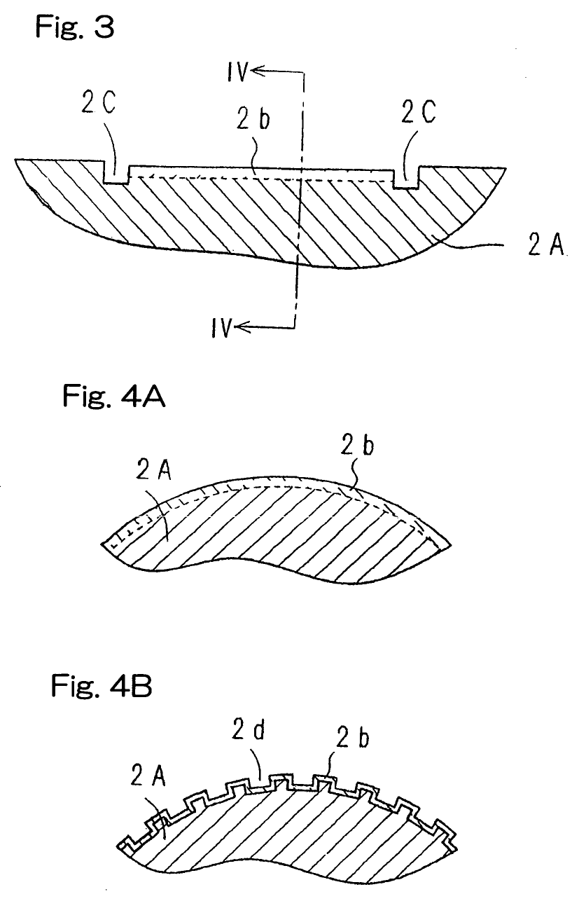

Also, the to-be-detected member 2b, which is the Al diffusion layer, may include a circumferentially extending groove 2c defined in the boundary between the Al diffusion layer and each of non-diffusion layers on respective sides of the Al diffusion layer as shown in FIG. 3. FIGS. 4A and 4B illustrate different examples of the to-be-detected member 2b in a cross-sectional representation taken along the line IV-IV in FIG. 3. Specifically, in the example shown in FIG. 4A, the to-be-detected member 2b is of a configuration, in which the aluminum is diffused on that entire cylindrical surface area of the outer peripheral surface of the hub axle 2A. Alternatively, as shown in FIG. 4B, that cylindrical surface area of the outer peripheral surface of the hub axle 2A may be, after a plurality of axially juxtaposed grooves 2d have been formed therein, be diffused with aluminum to form the to-be-detected area 2b.

Where the axially juxtaposed grooves 2d are formed in the cylindrical surface area of the outer peripheral surface of the hub axle 2A as shown in FIG. 4B, the sensitivity can be increased as the direction of electromagnetic strains generated as a result of an axial load acting therein can be concentrated in an axial direction. The axially juxtaposed grooves 2d may be formed by the use of either any known grinding process or any known knurling process and have a depth preferably within the range of 0.1 to 0.5 mm.

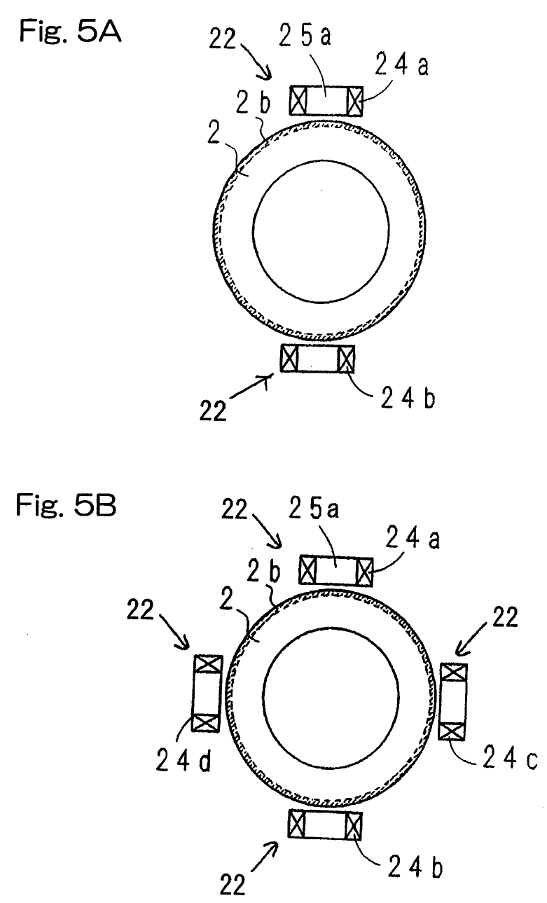

The structure of the force detecting unit 22 will now be described with particular reference to FIG. 5. In an example shown in 5A, the force detecting unit 22 includes two force detecting elements arranged radially outwardly of and in the vicinity of the inner member 2 at respective upper and lower locations lying in a vertical direction perpendicular to the longitudinal axis of the inner member 2, particularly the hub axle 2A, and spaced 180° from each other with respect to the longitudinal axis of the inner member 2. Those two force detecting elements are in the form of coiled windings 24a and 24b, which are held at the respective upper and lower locations while confronting the to-be-detected member 2b, that is in the form of the magnetostrictive element formed on that cylindrical surface area of the outer peripheral surface of the hub axle 2A, so as to detect change in magnetic strain. Thus, in the event that a vertically acting bending moment load tending to tilt the vehicle wheel 18 acts on the inner member 2, a tensile force (or a compressive force) acts on the upper to-be-detected member 2b held at the upper location and, on the other hand, a compressive force (or a tensile force) acts on the lower to-be-detected member 2b.

Respective magnetic reluctances of those coiled windings 24a and 24b undergo change in dependence on the tensile force and the compressive force acting respectively on the upper and lower to-be-detected members 2b, and the magnitude of such change is indicative of the bending moment load acting on the vehicle wheel 18. Specifically, if the difference between the respective magnetic reluctances of the upper and lower coiled windings 24a and 24b is calculated, the vertically acting bending load acting on the hub axle 2A can be detected. On the other hand, if the sum of the respective magnetic reluctances of the upper and lower coiled windings 24a and 24b is calculated, the axially acting load acting on the hub axle 2A can be detected.

In an alternative example shown in FIG. 5B, additional two force detecting elements are employed in the arrangement shown in and described with reference to FIG. 5A. Those additional two force detecting elements are similarly arranged radially outwardly of and in the vicinity of the inner member 2, but at respective right and left locations lying in a horizontal direction perpendicular to the longitudinal axis of the inner member 2 and spaced 180° from each other with respect to the longitudinal axis of the inner member 2. The right and left force detecting elements are also similarly in the form of coiled windings 24c and 24d, respectively.

With the force detecting unit 22 of the structure shown in and described with reference to FIG. 5B, not only can the vertically acting bending load be detected with the upper and lower coiled windings 24a and 24b, but the horizontally acting bending load can also be detected with the right and left coiled windings 24c and 24d. Where the force detecting unit 22, in which the four coiled windings 24a to 24d are employed at the upper, lower, right and left locations with respect to the inner member 2, the load acting axially on the hub axle 2A can be indicated by the sum of changes of the magnetic reluctances detected respectively by the four coiled windings 24a to 24d.

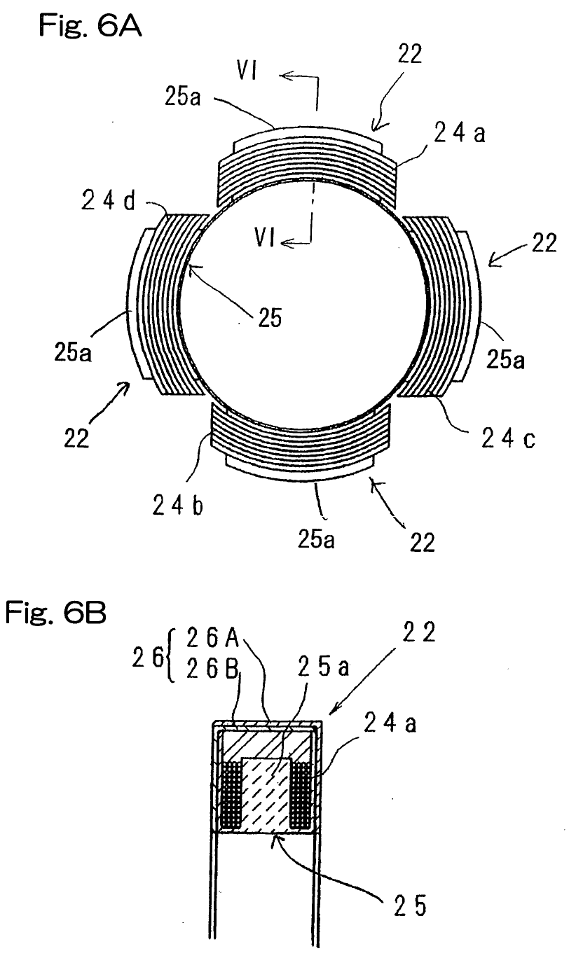

The details of the force detecting unit 22 shown in and described with reference to FIG. 5B are best shown in FIG. 6. As shown therein, the force detecting unit 22 includes a bobbin 25 made of a resin and arranged on an outer periphery of the hub axle 2A in coaxial relation with the hub axle 2A. This bobbin 25 has circumferentially equidistantly spaced radial projections 25a protruding radially outwardly therefrom, two of which lie in the vertical direction perpendicular to the longitudinal axis of the inner member 2 and the remaining two of which lie in the horizontal direction perpendicular to the longitudinal axis of the inner member 2. The windings 24a to 24d referred to previously are wound around those radial projections 25a, respectively. The bobbin 25 carrying the coiled windings 24a to 24d wound around the respective radial projections 25a is covered with a ring-shaped yoke 26 of a generally U-sectioned configuration made of a magnetic material and extending from one side to the opposite side over an outer periphery, with a molded resin subsequently filled inside the yoke 26. The yoke is 26 made up of a generally L-sectioned right yoke member 26A and a generally L-sectioned left yoke member 26B, and the bobbin 25 is substantially sandwiched between the right and left yoke members 26A and 26B so that the yoke 26 covers the bobbin 25.

The force detecting unit 22 of the structure described above is press fitted into the outer member 1 so as to be seated at a location intermediate between the raceway grooves 4 in alignment with the to-be-detected member 2b defined in the outer peripheral surface area of the hub axle 2A. At this time, the inner peripheral surface of the yoke 26 is spaced a predetermined distance from the to-be-detected member 2b on the hub axle 2A. An output from the force detecting unit 22 disposed radially inwardly of the outer member 1 is drawn to the outside of the outer member 1 by means of a connection cable 35 as shown in FIG. 2.

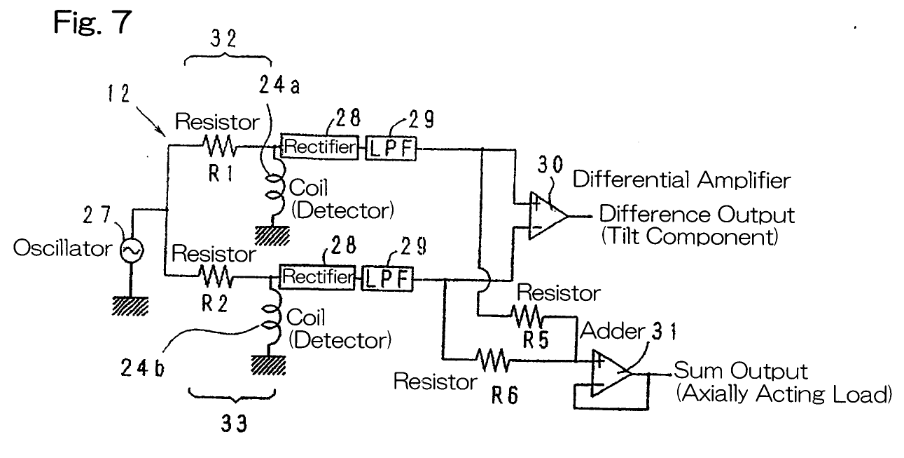

FIG. 7 illustrates an example of a processing circuit 12 for processing a detection signal outputted from the force detecting unit 22. This processing circuit 12 is applicable to and operable with the force detecting unit 22 of the structure including the upper and lower coiled windings 24a and 24b shown in FIG. 5A and is used to detect the vertically acting bending load and the axially acting load.

Referring particularly to FIG. 7, the processing circuit 12 includes a first series connected circuit 32 made up of the coiled winding 24a and a resistor R1, a second series connected circuit 33 made up of the coiled winding 24b and a resistor R2 and connected in parallel to the first series connected circuit 32, and an oscillator 27 for supplying an alternating current voltage of a few tens kHz to both of the first and second series connected circuits 32 and 33. A divided voltage across the first coiled winding 24a is converted by means of a rectifier 28 and a low pass filter 29 into a direct current voltage, which is subsequently supplied to a first input terminal of a differential amplifier 30. Also, a divided voltage across the second coiled winding 24b is converted by means of a rectifier 28 and a low pass filter 29 into a direct current voltage, which is subsequently supplied to a second input terminal of the differential amplifier 30. The differential amplifier 30 outputs a signal indicative of the difference between those two inputs from the first and second series connected circuits 32 and 33. An output from the differential amplifier 30 is an indication of a tilt component of the load, that is, the vertically acting load (the bending direction) acting on the hub axle 2A. The two inputs referred to above are supplied to and are therefore summed by an adder 31 through respective resistors R5 and R6. A sum output from the adder 31 is indicative of the magnitude of the load, that is, the load acting in an axial direction of the hub axle 2A. Thus, with the addition of the adder information, both of the magnitude of the bending load including the bending direction and the axially acting load can be detected with precision.

Those outputs may be processed in a circuit board either provided in a portion of the automotive body structure remote from the wheel support bearing assembly or fixed to the vehicle body fitting flange 1a that is rigidly connected with the knuckle 14. Where the circuit board is fixed to the vehicle body fitting flange 1a, information on the load processed in such circuit board may be transmitted wirelessly to a receiving means mounted on the vehicle body structure through a transmitting means 34 shown in FIG. 1. In such case, supply of an electric power to the circuit board may also be carried out wirelessly.

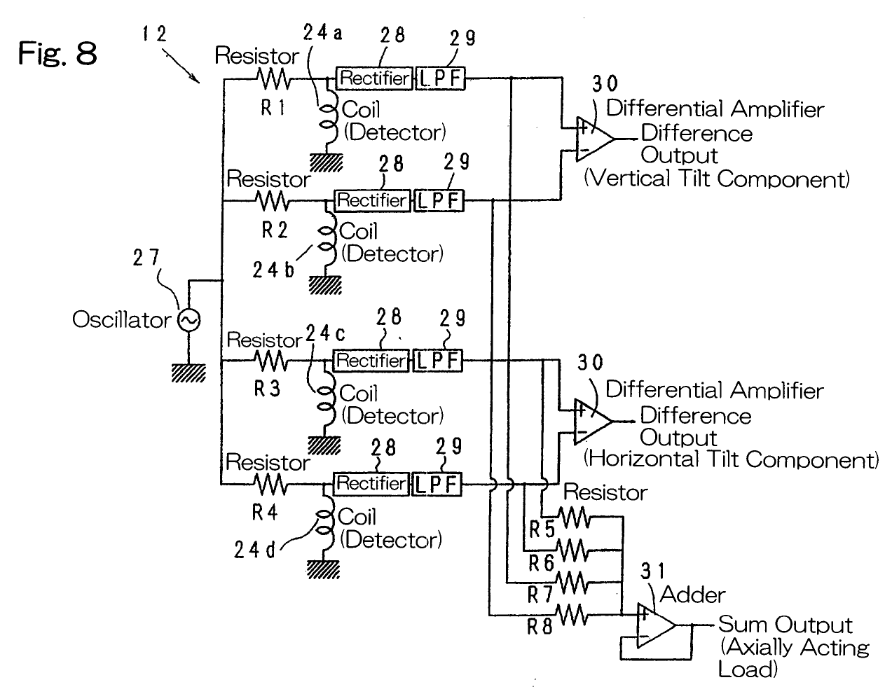

FIG. 8 illustrates a different example of the processing circuit for processing a detection signal outputted from the force detecting unit 22. This processing circuit 12A is applicable to and operable with the force detecting unit 22 of the structure including the upper, lower, right and left coiled windings 24a, 24b, 24c and 24d shown in FIG. 5B and is used to detect the vertically and horizontally acting bending loads and the axially acting load.

The detection of the horizontally acting load performed by this processing circuit 12A is substantially similar to that accomplished with the processing circuit 12 shown in and described with reference to FIG. 7. Also, if respective signals from the four coiled windings 24a to 24d, which have been passed through the corresponding low pass filters 29, are supplied to an input terminal of the adder 31 through associated resistors R5, R6, R7 and R8 to detect the axially acting load, the load acting axially of the hub axle 2A can be detected. Even in this case, with the addition of the adder information, both of the magnitude of the bending load including the bending direction and the axially acting load can be detected.

As hereinabove described, since in this wheel support bearing assembly the load sensor 9 is disposed in the space bound between the raceway grooves 4 and 5 for the dual rows of the rolling elements 3, the load sensor 9 can be snugly and neatly mounted on the automotive vehicle. Also, since the output from the load sensor 9 undergoes change when the bending load, or the load in the form of the compressive force or the tensile force acts on the hub axle 2A, the change in load acting on the vehicle wheel 18 can be detected. Accordingly, when the automobile suspension system, for example, is controlled in advance by capturing the change in output from the load sensor 9 as information, control of the attitude of the automotive vehicle such as, for example, prevention of the rolling during the cornering, prevention of the nose dive during the braking, prevention of lowering of the level of the automotive vehicle resulting from uneven distribution of payloads and so on can be accomplished.

Also, since the load sensor 9 referred to hereinbefore cooperates with the load detecting element having its electric characteristic variable in dependence on the applied load, which element is employed in the form of the Fe—Al alloyed layer having a considerable magnetostrictive effect, not only can detection of the load acting on the hub axle 2A be easily achieved with high sensitivity, but also the signal processing circuit 12 or 12A for processing the detected load signal can be simply assembled as shown in FIG. 7 or FIG. 8, respectively.

Although the Fe—Al alloy having a high magnetostrictive effect is generally fragile, formation of the Fe—Al alloy on a portion of the surface of the structural steel by the use of the aluminum diffusion technique is believed to have resulted in no substantial reduction in strength and, hence, to have resulted in a mechanical strength comparable to that exhibited by the structural steel.

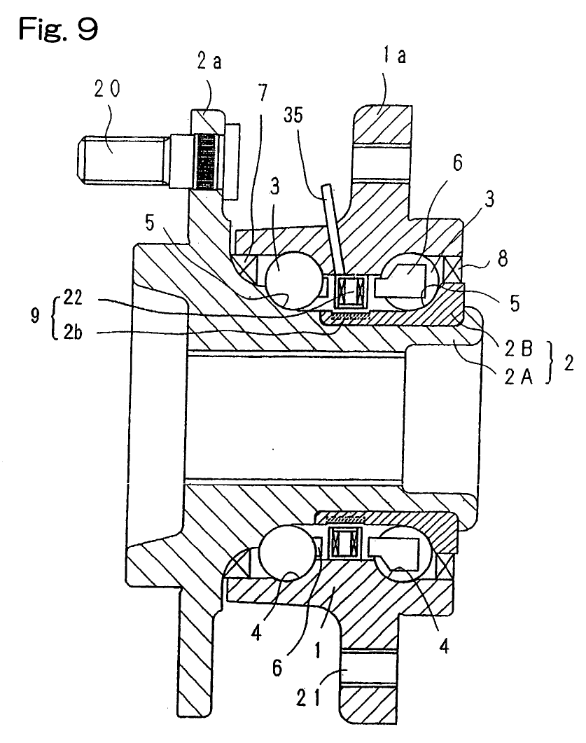

Moreover, although in the foregoing embodiment, the detected load signal from the load sensor 9 has been shown and described as transmitted through the connection cable 35, the use may be made of the transmitting means 34 (shown by the phantom line in FIGS. 1 and 2) so that the detected load signal can be transmitted wirelessly. In such case, the use of the connection cable 35 or any other wiring between the load sensor 9 and a control device on the side of the automotive vehicle structure that receives the detected load signal can be advantageously dispensed with, allowing the load sensor 9 to be neatly and snugly installed. The wheel support bearing assembly according to a second preferred embodiment of the present invention is shown in FIG. 9. This wheel support bearing assembly shown in FIG. 9 is substantially similar to that shown in and described with reference to FIGS. 1 to 8 in connection with the first embodiment of the present invention, but differs therefrom in that in place of the to-be-detected member 2b in the form of the magnetostrictive element that is formed on that specific surface area of the peripheral surface of the hub axle 2A in the previously described first embodiment, the to-be-detected member 2b is formed in a cylindrical surface area of an outer peripheral surface of the inner race segment 2B, specifically between an outboard end thereof and the raceway groove 5.

Other structural features of the wheel support bearing assembly according to the second embodiment are similar to those of the wheel support bearing assembly according to the previously described first embodiment and, therefore, the details thereof are not reiterated for the sake of brevity.

In the case of the second embodiment described above, since the inner race segment 2B is relatively small in size as compared with the hub axle 2A, the aluminum diffusion treatment to form the to-be-detected member 2b in the inner race segment 2B can be simplified advantageously.

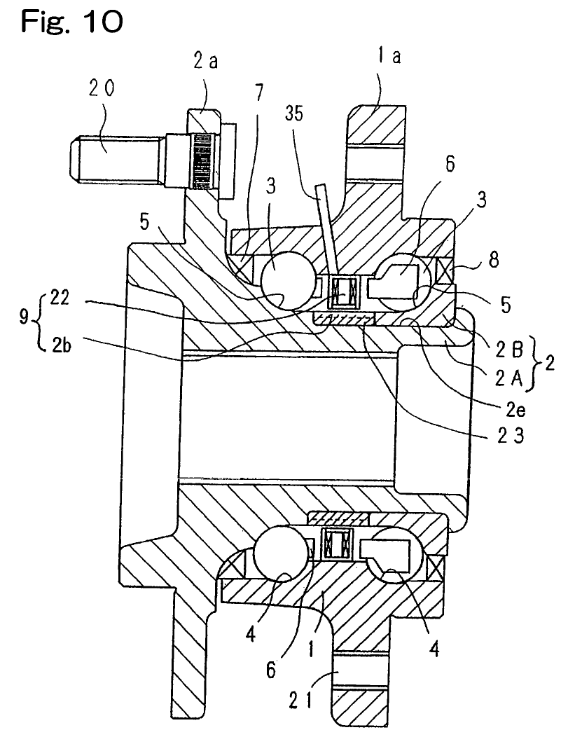

FIG. 10 illustrates the wheel support bearing assembly according to a third preferred embodiment of the present invention. This wheel support bearing assembly shown in FIG. 10 is substantially similar to that shown in and described with reference to FIGS. 1 to 8 in connection with the first embodiment of the present invention, but differs therefrom in that a cylindrical mounting region 2e of the hub axle 2A, where the inner race segment 2B is mounted, is so undersized in diameter relative to the raceway groove 5 and is extended a distance towards the outboard side beyond the axial region where the inner race segment 2B is seated and that a ring-shaped magnetostrictive member 23 is press-fitted onto that portion of the cylindrical mounting region 2e of the hub axle 2A, which has been extended towards the outboard side. The ring-shaped magnetostrictive member 23 has the to-be-detected member 2b in the form of the aluminum diffusion layer formed on a surface layer thereof. It is, however, to be noted that the magnetostrictive member 23 may be fixed on the hub axle 2B by means of a laser welding applied to the interface between it and the hub axle 2A.

In the case of the third embodiment, the to-be-detected member 2b need not be formed directly in either the hub axle 2A or the inner race segment 2B and, therefore, the processing of the hub axle 2A or the inner race segment 2B can be facilitated advantageously.

It is to be noted that in any one of the embodiments shown in and described with reference to FIGS. 9 and 10, respectively, the to-be-detected member 2b in the form of the aluminum diffusion layer may have the circumferentially extending grooves 2c such as shown in FIG. 3 and/or the axially juxtaposed grooves 2d.

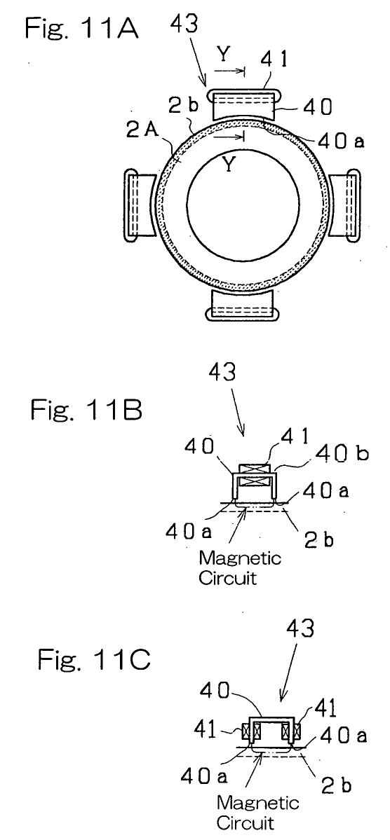

FIG. 11 illustrates a modified form of the force detecting unit 22 shown in FIG. 5. This modified force detecting unit is now identified by 43 and includes yokes 40 of a generally U-sectioned configuration so arranged as to form respective magnetic circuits developed in the axial direction. Each of those yokes 40 has opposite free ends 40a so curved inwardly arcuately as to follow the curvature of the outer periphery of the to-be-detected member 2b in the form of the magnetostrictive element formed in the outer peripheral surface of the hub axle 2A, but spaced a predetermined distance from the outer periphery of the to-be-detected member 2b.

Two different specifications of each of the coiled windings, shown in a cross-sectional view taken along the line Y-Y in FIG. 11A, are shown in FIGS. 11B and 11C, respectively. In the example shown in FIG. 11B, a coiled winding 41 is wound around a surface portion 40b of each of the yokes 40 that is remote from the to-be-detected member 2b. On the other hand, in the example shown in FIG. 11C, the coiled winding 41 is wound around surface portions of the respective yoke 40 that contain the yoke free ends 40a.

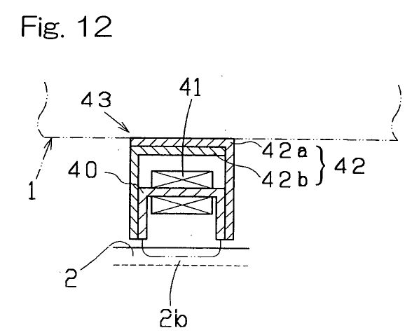

In those examples shown in FIGS. 11B and 11C, respectively, the yokes 40 including the respective coiled windings 41 are arranged at upper, lower, left and right locations in a manner similar to those shown in FIG. 11A. Those yokes 40 including the respective coiled windings 41 form the force detecting unit 43 as shown in FIG. 12. In this force detecting unit 43, each of the yokes 40 is sandwiched between a pair of left and right annular metallic casings 42a and 42b, each representing a generally L-sectioned configuration, and fixed in position by means of a resinous material. The force detecting unit 43 is fixedly mounted on the outer member 1 having been press-fitted into the axial bore of the outer member 1. Each of the metallic casings 42a and 42b is preferably made of a non-magnetic metallic material.

When an alternating current is supplied to the coiled windings 41 each representing a yoke shape, magnetic circuits are developed in the to-be-detected member 2b in the axial direction and, therefore, strains induced in the axial direction of the to-be-detected member 2b as a result of the bending moment acting on the hub axle 2A can be detected with high sensitivity. Even in this example, the signal processing circuit may be substantially identical with that shown in and described with reference to any one of FIGS. 7 and 8. It is to be noted that, although the foregoing description has been made in connection with the to-be-detected member 2b having no axially juxtaposed grooves formed on the outer peripheral surface thereof, the to-be-detected member 2b employed in each of those examples may have the axially juxtaposed grooves and that the sensitivity will be high with the use of the axially juxtaposed grooves on the outer peripheral surface of the to-be-detected member 2b.

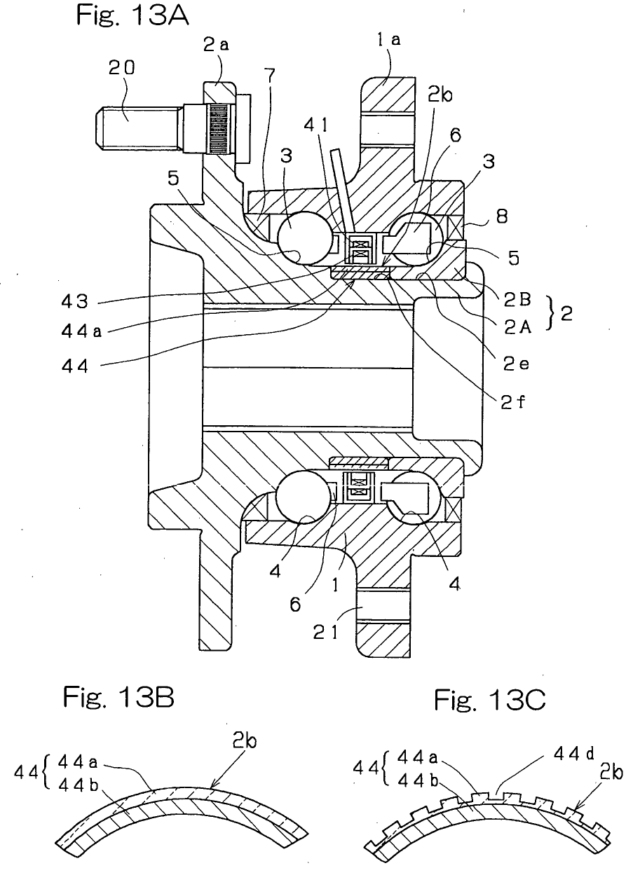

FIG. 13 illustrates the wheel support bearing assembly according to a fourth preferred embodiment of the present invention. Unless otherwise specifically described hereinafter, the wheel support bearing assembly shown in FIG. 13 is substantially similar to that shown in and described with reference to FIGS. 1 to 8 in connection with the first embodiment of the present invention.

Although a bulk material of the Fe—Al alloy is known as a material having an excellent magnetostrictive characteristic, a problem with it is that it is fragile. As a means for resolving this problem, in the example shown in FIG. 13A, a ring shaped magnetostrictive member 44 prepared from an Fe—Al clad steel is mounted under interference fit on a mounting surface area 2f of the hub axle 2A as a means for forming the to-be-detected member 2b in the form of the magnetostrictive element. The Fe—Al clad steel is a magnetostrictive material formed integrally with an alloyed layer on a surface of a steel member by means of a hot plastic working, which alloyed layer contains aluminum in a quantity within the range of 5 to 17 mass % and the remainder being iron and unavoidable impurities. The ring shaped magnetostrictive member 44 referred previously is made up of a matrix 44b of carbon steel such as, for example, S45C and a magnetostrictive layer 44a in the form of an alloyed layer containing 13 mass % of aluminum and formed on an outer peripheral surface of the carbon steel matrix 44b as shown in FIG. 13B. The magnetostrictive member 44, after having been shaped into a ring-like configuration, then hardened overall and ground at a required location, press-fitted onto the mounting surface area 2f of the hub axle 2A. After the press-fitting onto the mounting surface area 2a, the ring shaped magnetostrictive member 44, which eventually forms the to-be-detected member 2b, and the hub axle 2A may be integrated together by means of a laser welding applied to the interface therebetween, but when it comes to welding, the hub axle 2A and the matrix 44 of the ring shaped magnetostrictive member 44 may be welded together. Other than the welding, a diffusion bonding may be employed.

Alternatively, as shown in FIG. 13C, the ring shaped magnetostrictive member 44 forming the to-be-detected member 2b may have axially juxtaposed grooves 44d formed on an outer surface of the magnetostrictive layer 44a, or the alloyed layer may have its surface subjected to a shot peening to increase the residue stress.

As compared with the Fe—Al bulk material, the Fe—Al clad steel has a superior strength and also has a high strength of bonding with the matrix 44b in the form of a carbon steel. Therefore, not only can the Fe—Al clad steel be advantageously used as the to-be-detected member 2b for the detection of the load, but also the Fe—Al clad steel has an excellent magnetostrictive characteristic and, therefore, the sensitivity can be increased. It is, however, to be noted that the ring shaped magnetostrictive member 44 having no matrix, but having only the Fe—Al alloyed layer may be fixedly mounted on the hub axle 2A to thereby form the to-be-detected member 2b.

As best shown in FIG. 13A, the force detecting unit 43 including the coils is arranged in face-to-face relation with the magnetostrictive member 44a forming the to-be-detected member 2b. The force detecting unit 43 may be of a structure shown in and described with reference to, for example, FIGS. 11 and 12 or of a structure shown in and described with reference to FIGS. 5 and 6. In such case, the bending moment can be detected by obtaining an output signal indicative of the difference in magnetic reluctance between every two of the coiled windings 41 that are spaced 180° from each other. But a component synchronized with rotation of the hub axle 2A may appear in the output signal.

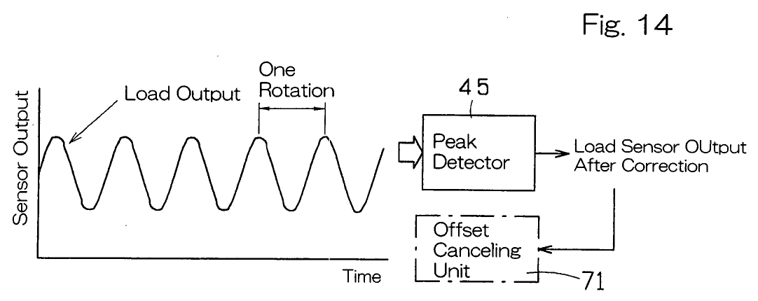

FIG. 14 illustrates an example of the output signal containing the rotation synchronized component referred to above. The output signal is affected by the roundness of the to-be-detected member 2b in the form of the magnetostrictive element on the hub axle 2A, the roundness of each of the yoke free ends 40a confronting the to-be-detected member 2b and the precision of the coaxial relation between the to-be-detected member 2b and the yoke free ends 40a, as well as change of the gap between the to-be-detected member 2b and the yoke free ends 40a. In order to alleviate those problems, influence on the output brought about by the synchronization with rotation can be minimized if the surface of the to-be-detected member 2b is ground, or, after the yokes 40 have been press-fitted into the axial bore of the outer member 1, respective inner peripheral portions of the yoke free ends 40 are ground to increase the precision. While the description is made with reference to FIG. 13A, the foregoing can be equally applied to any one of the various embodiments shown in FIGS. 1 to 13.

In order to remove the rotation synchronized component, the grinding has been described as performed on the yokes 40 of the force detecting unit 43 and the to-be-detected member 2b confronting the force detecting unit 43. However, correction can be accomplished through processing with a circuit. The correcting circuit means will now be described with particular reference to FIG. 14.

The rotation synchronized component brings about one or more cycles of sensor output change each time the hub axle 2A undergoes one complete rotation. The hub axle 2A generally rotates at a speed equal to the rotational speed of the vehicle wheel and the frequency of the synchronized component varies with the vehicle running speed, i.e., from a few Hz at a low rotational speed to some tens Hz at a high speed. Since this frequency is low, it is not easy to remove the change even when the sensor signal is passed through a low pass filter. In view of this, if the peak value of the sensor output signal is detected and is used as a load signal, the synchronized component can be removed completely. For detecting the peak value, the use may be made of a peak detecting circuit 45 at the subsequent stage of the force detecting unit 43 so that the load signal can be subjected to a correction process. A circuit for capturing the sensor signal, which has been subjected to an analog-to-digital conversion, in a central processing unit (CPU) and for performing a data processing to detect the peak value is incorporated in the peak detector circuit 45. Alternatively, an analog circuit can be employed, which is so designed as to detect the peak value for each synchronized component.

Where the coils are employed for the force detecting unit 43, it may often occur that the output from the force detecting unit 43 is offset direct-currently, that is, a predetermined value depending on the temperature and environment in which it is used. While the means for detecting the difference between the respective outputs from the two coils or for performing the correction based on information from the temperature sensor has been described previously, it may also be contemplated to use an offset canceling unit 71 (See FIG. 14) with which a sensor output generated during parking of the automotive vehicle or during straight run of the automotive vehicle at which the load on the wheel axle is small can be zeroed to instantaneously cancel the offset.

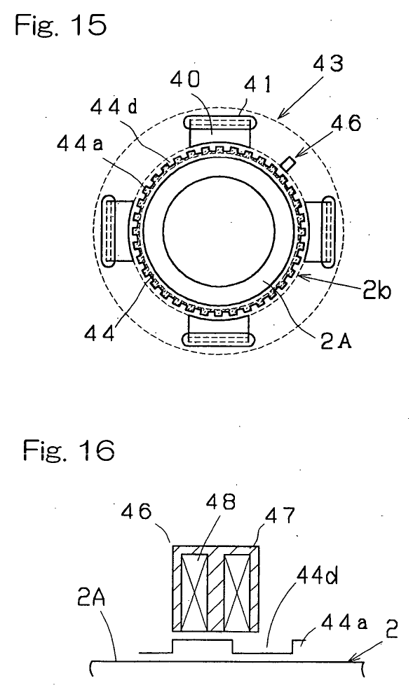

FIG. 15 illustrates an addition of a function of detecting the rotation by the use of the to-be-detected member 2b to the wheel support bearing assembly shown in and described with reference to FIG. 13. It is widely considered feasible to add the function of detecting the rotation to the wheel support bearing assembly as a rotation signal can be employed in a control to improve the running stability such as in the anti-lock brake system (ABS). However, the example shown in FIG. 15 is so designed as to achieve this with no necessity of additionally employing component parts such as, for example, a magnetic encoder.

Specifically, in the example shown in FIG. 15, surface irregularities represented by the formation of the axially juxtaposed grooves 44d on an outer surface of the magnetostrictive element of the to-be-detected member 2b employed to detect the load are employed as an encoder. In a circumferential gap which is the same as that formed between the two neighboring yokes 40 of the load sensors arranged on the circumference above the circumference of the to-be-detected member 2b, a rotation detecting member 46 is embedded within the force detecting unit 43 while spaced a predetermined distance from the to-be-detected member 2b. The rotation detecting member 46 is, as best shown in FIG. 16, made up of a yoke 47 made of a ferrite material, and a coil 48 wound in a ring shape within the yoke 47. This rotation detecting member 46 functions as a gap sensor and is operable to detect the presence or absence of the axially juxtaposed grooves 44d on the outer surface of the to-be-detected member 2b during rotation of the hub axle 2A.

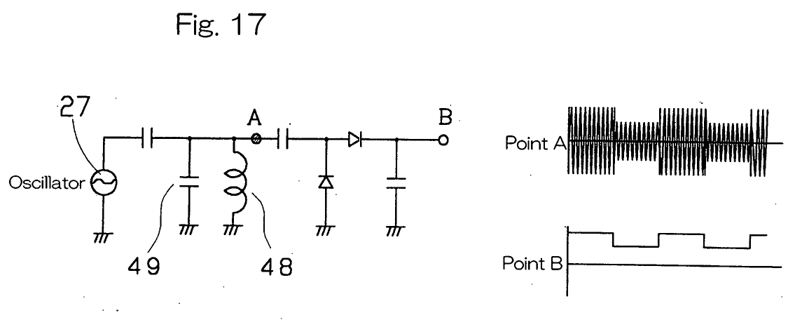

An example of the circuit for the detection of the rotation is shown in FIG. 17. As shown therein, the rotation detecting circuit forms a resonance circuit including the coil 48 and a capacitor 49 when the coil 48 is excited at some tens KHz. As the hub axle 2A undergoes rotation, the amplitude of a signal at a point A of the circuit varies depending on the presence or absence of the axially juxtaposed grooves 44d and, when being subsequently rectified and smoothened, a rotation signal of a rectangular waveform can be obtained (at a point B of the circuit). Respective waveforms of the signal appearing at the points A and B are also shown in FIG. 17.

It is, however, to be noted that the sensor for the detection of the rotation is not always limited to that described above, but a gear tooth sensor, in which a Hall sensor and a magnet are employed, or the like can be equally employed. Thus, if two kinds of signals can be detected from the single to-be-detected member 2b, it can contribute to compactization of the wheel support bearing assembly. Also, in the case where those signals are drawn out by means of wiring, they can be put together and, therefore, the number of connector junctions can be reduced during assemblage.

Also, the number of the rotation detecting member 46 may not be always limited to one, but two rotation detecting members may be employed, in which case they should be so arranged that the difference in phase between respective rotation signals output therefrom can be spaced 90° from each other. Thus, if the rotation signals spaced 90° in phase from each other can be detected, the direction of run of the automotive vehicle can be ascertained and, therefore, it is possible to detect a backward movement of the automotive vehicle such as occurring on a slope, with a control range consequently expanding to encompass a hill hold. In this example, although reference has been made to the embodiment shown in FIG. 15, in which the ring shaped magnetostrictive member 44 prepared from the Fe—Al alloy is fixedly mounted on the hub axle 2A, the to-be-detected member 2b in the form of the magnetostrictive layer may be formed directly on the hub axle 2A with axially juxtaposed grooves formed on the surface thereof.

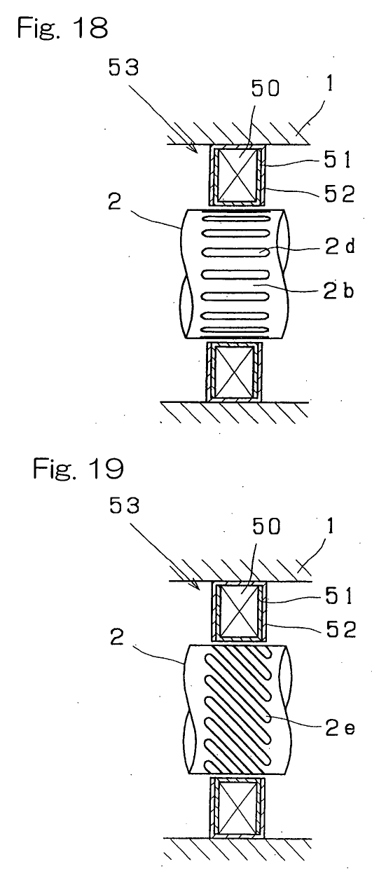

FIGS. 18 and 19 illustrate a fifth and a sixth embodiments of the present invention, respectively. In the foregoing description, reference has been made mainly to the detection of the bending moment as the load detection and also to calculation made using output values from the plural detecting members where detection of the axially acting load is required. However, in each of the examples shown in FIGS. 18 and 19, respectively, arrangement is made to directly detect a load axially acting on a shaft. It is to be noted that in each of FIGS. 18 and 19, the outer member 1 and the inner member 2 are schematically shown.

In the example shown in FIG. 18, the to-be-detected member 2b in the form of the magnetostrictive element has a plurality of axially juxtaposed grooves 2d formed therein and arranged equidistantly spaced from each other in a direction circumferentially thereof, each axially juxtaposed grooves 2d having a depth of about 0.5 mm.

A force detecting unit 53 is fixedly mounted inside the bore of the outer member 1 at a location confronting and spaced a predetermined distance from the to-be-detected member 2b. A coil 50 is wound around a bobbin 51, made of a resinous material, in a fashion coaxial with the to-be-detected member 2b. This bobbin 51 is retained by yoke 52 made of a magnetic material and press-fitted into the bore of the outer member 1. It is to be noted that the coil 50 may be finally fixed in position by means of a resin molding.

In the illustrated example, a change in magnetic strain developed axially in the axially juxtaposed grooves 2d as a result of the axially acting load is detected by the coil 50 over the entire circumference of the magnetostrictive element.

FIG. 19 illustrates an example grooves 2e similar to the axially juxtaposed grooves 2d that are inclined at an angle of 45° relative to the axis, but the force detecting unit 53 shown therein is substantially similar to that shown in and described with reference to FIG. 18. This structure functions as a torque sensor and, accordingly, when a torque develops on the to-be-detected member 2b, the magnetic permeability undergoes a slight change by the effect of a shearing stress developed in a 45° angled direction, which change is detected by the coil 50 of the force detecting unit 53 as a change in impedance. This output represents the value of the torque applied. The hub axle 2A has a tire coupled therewith, which is not shown, and, therefore, the torque proportional to a running condition such as during a braking or slippage can be detected.

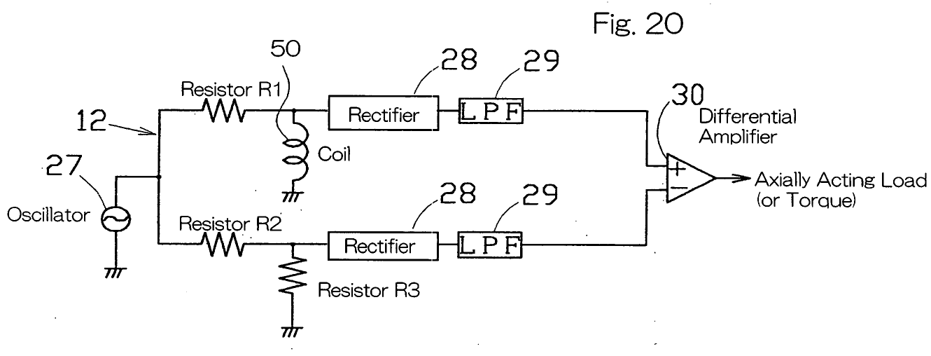

FIG. 20 illustrates an example of the processing circuit 12 used to detect the axially acting load and the torque shown in FIGS. 18 and 19. Since only one coil 50 is employed, the system shown therein is of a design in which the difference is calculated with a resistor R3 employed in place of a portion corresponding to the coil 50.

It is to be noted in the case of the embodiment shown in FIG. 19, although not shown, the grooves inclined at an angle of ±45° relative to the axis may be so formed as to represent a shape generally similar to the shape of an inverted figure of “V” and the coil is employed for each of those grooves in face-to-face relation thereto.

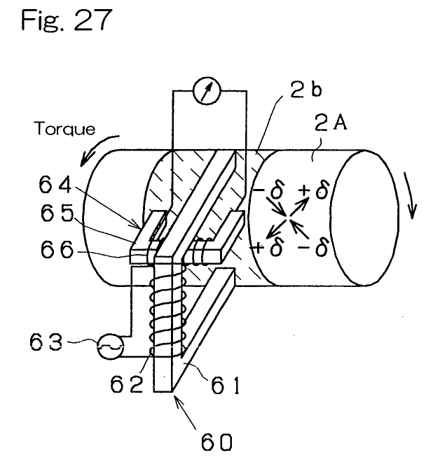

FIG. 27 illustrates a further modified form of the torque detecting means. A generally U-shaped exciting head 60 and a generally U-shaped detecting head 64 are arranged perpendicular to each other above the surface of the to-be-detected member 2b in the form of the magnetostrictive layer formed on the outer peripheral surface of the hub axle 2A, so that a predetermined gap can be formed between the exciting and detecting heads 60 and 64 and the to-be-detected member 2b that are held in non-contact fashion relative to each other. It is to be noted that no groove is formed in the surface region of the to-be-detected member 2b in this example.

The exciting head 60 includes a generally U-shaped yoke 61 and an exciting coil 62 wound in a plurality of turns around the yoke 61, which coil 62 is electrically connected with an exciting electric power source 63 so that an alternating magnetic field can be generated. On the other hand, the detecting head 64 includes a generally U-shaped yoke 65 and a detecting coil 66 wound in a plurality of turns around the yoke 65 and is operable to detect a change of an alternately magnetized component when the torque acts on an axial surface. Since the alternately magnetized component has its magnitude that varies depending on the magnitude and orientation of the shearing stress σ in the 45° angled direction, it is possible to detect the torque with the structure shown in FIG. 27.

When the torque is detected with the system shown in FIG. 19 or FIG. 27, the load F in the running direction can be detected from the torque T so obtained and the radius R of the wheel tire. In other words, F=T/R.

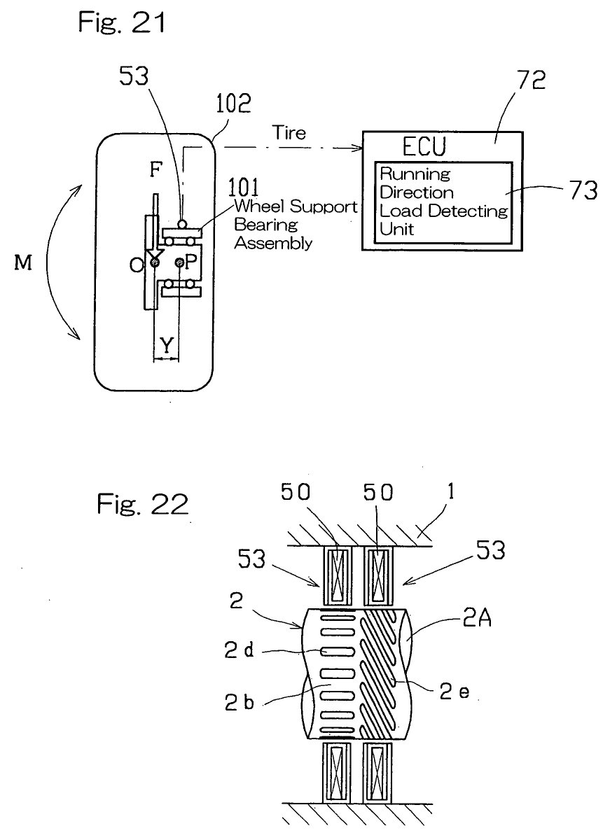

FIG. 21 illustrates the structure of the wheel tire 102 and the wheel support bearing assembly 101 as viewed from top of the vehicle body structure. The load F acting from the bending moment M in the horizontal direction on a point O of support of the wheel tire in a direction conforming to the running direction can be calculated from distance Y between a point P of support of the wheel support bearing assembly 101 and the point O of support of the load F, i.e., F=M/Y. A detecting unit 73 for detecting the load acting in a direction conforming to the running direction, shown in FIG. 21, serves as means for calculating the load F acting in the direction conforming to the running direction. If the bending moment acting in the horizontal direction is small, calculation of the load F, acting in the direction conforming to the running direction, through detection of the torque appears effective to provide a high output in terms of sensitivity. The load detecting unit 73 for detecting the load acting in the direction conforming to the running direction may be used to calculate the load F acting in the direction conforming to the running direction through detection of the torque as described above. This load detecting unit 73 is provided in, for example, an electric control unit (ECU) such as, for example, a computer employed in the automotive vehicle.

It is to be noted that two detecting functions as a load sensor and a torque sensor shown in FIGS. 18 and 19, respectively, may be incorporated in a single wheel support bearing assembly as shown in FIG. 22 illustrating a seventh embodiment. Also, a portion that serves as the torque sensor shown in FIG. 22 may be so constructed as shown in FIG. 27. Yet, the to-be-detected member 2b in the form of the magnetostrictive element may be formed integrally with the hub axle 2A, or may be formed in a ring shaped member made of a magnetostrictive material, for example, a clad steel or an Al diffused steel and subsequently fixedly coupled with the hub axle 2A. By so doing, both of the axially acting load on the wheel support bearing assembly and the torque or the load acting in the direction conforming to the running direction can be detected so that those signals can be used for the control of the running stability of the automotive vehicle and also for the reaction control in the steer-by-wire system.

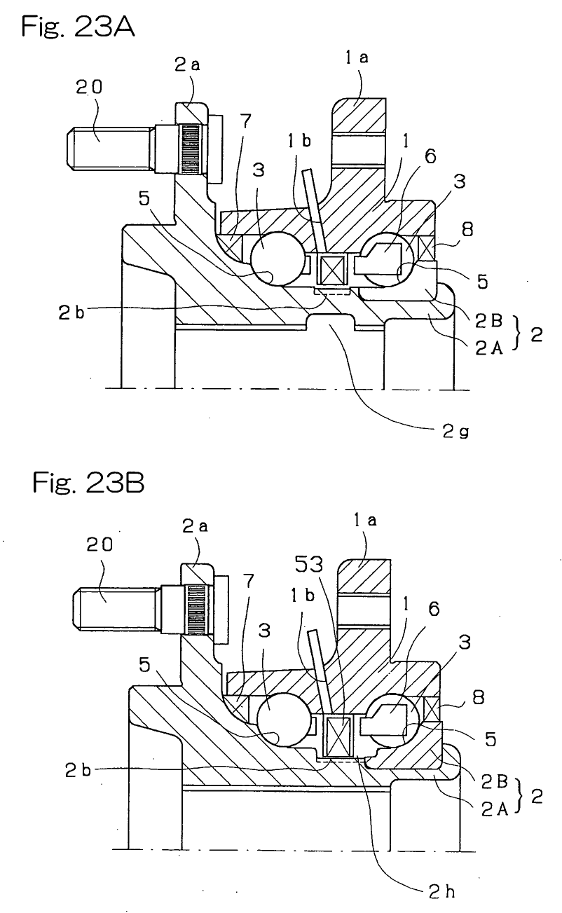

FIGS. 23A and 23B illustrate different preferred embodiments of the present invention, in which the load detecting sensitivity is increased while the Al diffusion technique is employed as the to-be-detected member 2b, respectively. In those embodiments, within the limit of rigidity required in the wheel support bearing assembly, the rigidity of a certain axial portion of the to-be-detected member 2b is lowered down to a value lower than that of the remaining portion of the to-be-detected member 2b to thereby increase the sensitivity.

Specifically, in the embodiment shown in FIG. 23A, a portion of the hub axle 2A corresponding to an inner peripheral side of the to-be-detected member 2b is recessed to define an annular thin-walled portion 2g. On the other hand, in the embodiment shown in FIG. 23B, the outer diameter of the to-be-detected member 2b is reduced by defining a radially inwardly stepped portion 2h. By so reducing the rigidity, the stress acting on the to-be-detected member 2b in the form of the magnetostrictive element increases, accompanied by increase of the magnetostrictive effect and, accordingly, an output gain can increase. Other structural features of, and effects obtained from, each of those embodiments shown respectively in FIGS. 23A and 23B are substantially similar to those shown and described with reference to FIGS. 1 to 8 in connection with the first embodiment of the present invention.

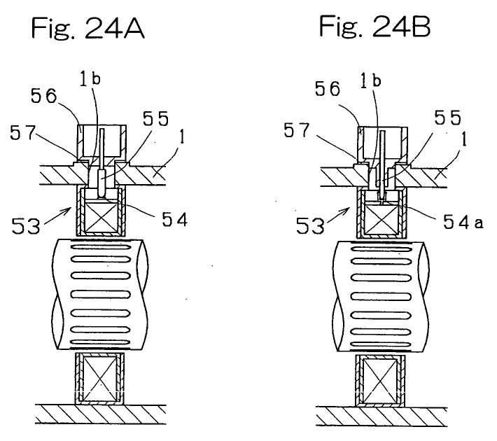

FIGS. 24A and 24B illustrate specific examples in which wirings are drawn from the force detecting unit 53, respectively. In the example shown in FIG. 23B, when the force detecting unit 53 is to be fixedly mounted inside the bore of the outer member 1 by means of, for example, a press-fitting technique, a cable must be passed through a throughhole 1b defined in the outer member 1. Alternatively, after the force detecting unit 53 has been press-fitted inside the bore of the outer member 1, a process for drawing the cable to the outside must be performed. For these reasons, press-fitting of the force detecting unit 53 requires a somewhat awkward assembling procedure. In view of this, the structure shown in each of FIGS. 24A and 24B has been devised.

In the example shown in FIG. 24A, opposite ends of the coil 50 in the force detecting unit 53 are exposed as respective electrodes 54 to a position free from interference with the press-fitting of the force detecting unit 53 and, in this condition, the force detecting unit 53 is press-fitted inside the outer member 1. Subsequently, terminal members 55 are inserted from the outside of the outer member 1 into the throughhole 1b so as to extend towards the electrodes 54 provided in the force detecting unit 53, followed by contact or connection thereof with the electrodes 54. By so doing, the signals within the force detecting unit 53 can be drawn to the outside through respective junctions between the electrodes 54 and the terminal members 55. The terminal members 55 referred to above may be integrated with a connector casing 56, with a packing 57 such as, for example, a water proof rubber sheet or O-ring interposed between the connector casing 56 and the outer member 1 to enhance the waterproof. It is to be noted that in order to increase the conductivity between the electrodes 54 and the terminal members 55, a biasing mechanism (not shown) such as, for example, a spring member may be built in each of the terminal members 55. Also, as shown in FIG. 24B, each of the electrodes may be rendered to be a generally U-shaped contact 54a with the corresponding terminal member 55 engaged inside the U-shaped contact 54a. To increase the electroconductivity of the electrodes 54 and the terminal members 55, the reliability will increase if they are plated with gold.

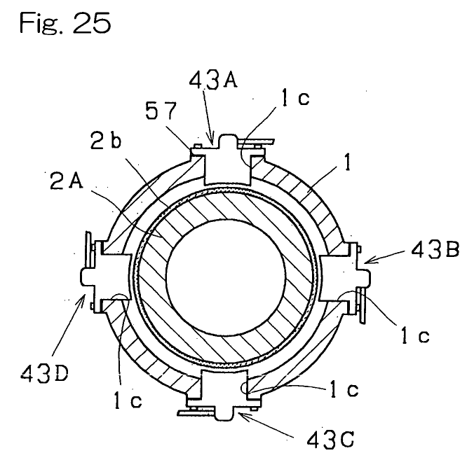

FIG. 25 illustrate an exemplary fixed mounting applicable where the force detecting unit 43 is divided into a plurality of detecting members such as in the embodiment shown in and described with reference to FIG. 11. In the example shown in FIG. 25, after the respective detecting members 43A, 43B, 43C and 43D have been molded in independent form, they are inserted and then fixed from outside of a throughhole 1c defined in the outer member 1. Even with this case, a packing 57 such as, for example, a rubber sheet or O-ring may be interposed between each of the detecting members 43A to 43D and the outer member 1.

With the structure shown in each of FIGS. 24 and 25, the force detecting unit 43 can be fixedly mounted from the outside of the outer member 1 and, at the same time, connection of the terminal members 55 can be accomplished from the outside of the outer member 1. Accordingly, the assemblability can be increased and the waterproofing treatment of the wiring can be simplified.

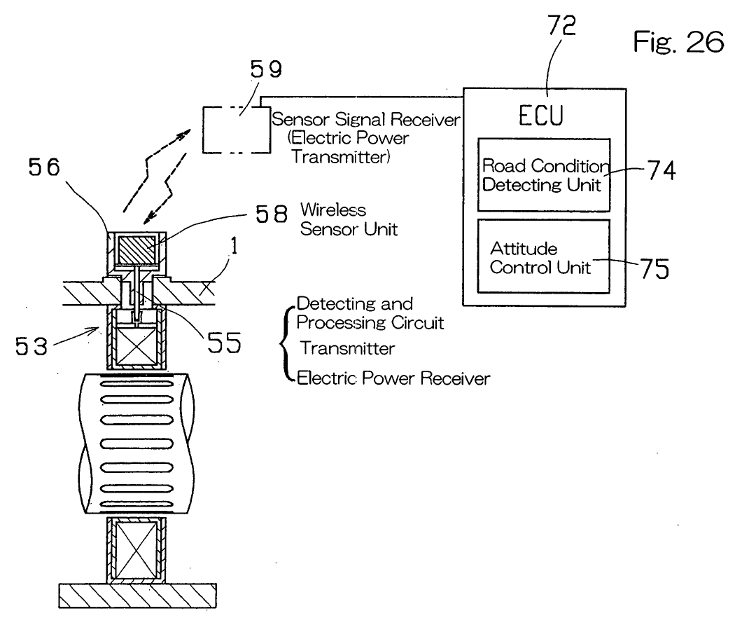

FIG. 26 illustrates an example designed to further increase the assemblability with no wiring employed. Specifically, the example shown in FIG. 26 is so designed as to enable signals and supply of an electric power to be transmitted and supplied wirelessly, respectively. In describing this example of FIG. 26, reference is made to that used in conjunction with the detection of the axially acting load. While the supply of an electric power and transmission of signals have hitherto been carried out by means of wiring, one or both of the supply of an electric power and the transmission of signals to the force detecting unit 53 may be carried out wirelessly. In the example shown in FIG. 26, an output signal from the force detecting unit 53 is drawn through the terminal members 55 to the connector casing 56 disposed outside of the outer member 1. The connector casing 56 has built therein a wireless sensor unit 58 including a detecting and processing circuit, a transmitting means and an electric power supply means and, on the other hand, transmission of sensor signals and supply of an electric power are carried out wirelessly between the wireless sensor unit 58 and a sensor signal receiving unit 59 which is positioned at a location remote therefrom and includes an electric power transmitting unit mounted on the automotive body structure. The transmission of the sensor signals and the supply of the electric power are carried out by the use of, for example, electromagnetic waves.

Regardless of whether it is wired or wireless, signal indicative of the load detected is transmitted to an electric control unit (ECU) 72 (not shown) provided on the side of the vehicle body structure and is then used for the control necessary to permit the automotive vehicle to be safely driven. As an example of the signal processing means for processing the load sensor signal in the electric control unit 72, unit 74 for detecting a road condition in reference to the frequency of the load signal or the amplitude of the signal may be employed and, based on the load signal or the signal indicative of the detected road condition, it can be used for the reaction control in the steer-by-wire system. Also, as an another example of the signal processing means for processing the load sensor signal in the electric control unit 72, unit 75 for controlling the attitude of the vehicle body structure by means of, for example, a rear wheel steering may be employed.

The structure according to any one of the foregoing embodiments and effects and advantages delivered therefrom will now be described briefly.

Since the sensor-incorporated wheel support bearing assembly for rotatably supporting a vehicle wheel relative to a vehicle body structure in accordance with the present invention includes an outer member 1 having a plurality of raceway grooves 4 defined in an inner peripheral surface thereof and also having a vehicle body fitting flange 1a formed so as to extend radially outwardly from an outer periphery thereof, an inner member 2 having a corresponding number of raceway grooves 5 defined therein in alignment with the respective raceway grooves 4 in the outer member 1, plural rows of rolling elements 3 interposed between the raceway grooves 4 and the raceway grooves 5, a to-be-detected member 2b in the form of a magnetostrictive element excellent in magnetostrictive characteristic formed in a portion of the inner member 2 at a location intermediate between the two raceway grooves 5, a force detecting unit 22, 43 or 53 positioned at a location confronting the to-be-detected member 2b, and a load sensor 9 for detecting a load acting on a vehicle wheel, the load sensor 9 can be mounted on an automotive vehicle compactly. Since when the load acts as a compressive force or a tensile force on the vehicle fitting flange 1a, an output from the load sensor varies, a change of the load acting on the vehicle wheel can be detected.

When the load obtained from the load sensor is electrically processed, not only the load including the direction of bending, which acts on the vehicle wheel, but also the axially acting load, or the load in the direction conforming to the running direction based on the result of detection of the torque, can be detected.

Also, it can be used for the control of transmitting information on the road condition to the steering wheel maneuvered by the automobile driver in the steer-by-wire system in which the vehicle wheel and the steering system are not coupled mechanically.

Where the force detecting unit 53 (FIG. 18) is employed, which includes the coil that is wound in coaxial relation with the to-be-detected member 2b in the form of the magnetostrictive element formed on the inner member 2, the axially acting load on the wheel axle can also be detected. In such case, the axially juxtaposed grooves 2d (FIG. 18) may be provided on the surface of the magnetostrictive element.

The axially acting load so obtained can be used as a sensor information in the system such as, for example, the steer-by-wire system, in which the vehicle wheel and the steering wheel are not coupled mechanically, for transmitting information on the road condition to the steering wheel maneuvered by the automobile driver.

Also, the axially acting load and the torque can be detected simultaneously, if the axially juxtaposed grooves and the grooves inclined at an angle of 45° relative to the axis are parallel arranged on the surface of the to-be-detected member 2b in the form of the magnetostrictive element and, at the same time, a magnetic force detecting unit including the coiled winding coaxial with the axis is provided at a location confronting those grooves. It is to be noted that if the torque is detected, it is possible to convert to the load acting on the wheel axle in a direction conforming to the running direction.

By way of example, although not shown, in any one of the foregoing first to third embodiments, one or both of a rotation sensor and a temperature sensor may be employed in combination with the previously described load sensor 9. Yet, although in any one of the first to third embodiment, the inner member 2 has been shown and described as made up of the hub axle 2A and the inner race segment 2B, the present invention can be equally applied to the wheel support bearing assembly, in which the inner member 2 is made up of the hub axle and a plurality of inner race segments and also to the wheel support bearing assembly of a fourth generation type in which the inner member is made up of the hub axle and an outer race member of a constant velocity universal joint.

Also, in describing any one of the foregoing embodiments of the present invention, incorporation in the wheel support bearing assembly of the load sensor of a kind utilizing the magnetostrictive effect and disposition of the to-be-detected member 2b in the form of the magnetostrictive element at a location between the raceway grooves 5 and 5 in the bearing assembly have been described. However, respective positions of the to-be-detected member 2b in the form of the magnetostrictive element and the sensor comprising the force detecting unit confronting the to-be-detected member 2b are not always limited to such as shown and described previously, but may be anywhere else provided that the stress can be detected.

For example, the to-be-detected member 2b may not necessarily be provided in the inner member 2 and the to-be-detected member 2b in the form of the magnetostrictive element may be provided in one of the outer and inner members 1 and 2 while the force detecting unit 22, 43 or 53 for detecting the change in magnetic strain in the to-be-detected member 2b may be provided in the other of the outer and inner members 1 and 2. Alternatively, the both of the to-be-detected member 2b and the force detecting unit 22, 43 or 53 may be provided in one of the outer and inner members 1 and 2. By way of example, the to-be-detected member may have a sectional shape similar to the shape of a groove-shaped ring, with the force detecting unit in the form of a coil positioned inside the to-be-detected member. In any of those cases, although one of the outer and inner members 1 and 2 may serves as a stationary member while the other of the outer and inner member 1 and 2 serves as a rotatable member, the force detecting unit 22, 43 or 53 is preferably provided on one of the outer and inner members 1 and 2, which serves as the stationary member, for the convenience of electric wiring.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. c x Accordingly, such changes and modifications are, unless they depart from the scope of the present invention as delivered from the claims annexed hereto, to be construed as included therein.

What is claimed is:

1. A sensor-incorporated wheel support bearing assembly for rotatably supporting a vehicle wheel relative to a vehicle body structure, which assembly comprises:
an outer member having a plurality of raceway grooves defined in an inner peripheral surface thereof;
an inner member having a corresponding number of raceway grooves defined therein in alignment with the respective raceway grooves in the outer member, the inner member being positioned inside the outer member with an annular bearing space defined between it and the outer member;
plural rows of rolling elements interposed between the raceway grooves in the outer member and the raceway grooves in the inner member, respectively;
sealing members for sealing opposite open ends of the annular bearing spaces between the outer and inner members; and
a load sensor disposed within the annular bearing space for detecting change in magnetic strain to thereby detect a load acting on the bearing assembly.

2. The sensor-incorporated wheel support bearing assembly as claimed in claim 1, wherein the load sensor includes a to-be-detected member made up of a magnetostrictive element and disposed on the inner member, and a force detecting unit positioned in the outer member for detecting a change in magnetic strain occurring in the to-be-detected member.

3. The sensor-incorporated wheel support bearing assembly as claimed in claim 2, wherein the to-be-detected member is positioned substantially intermediate between the raceway grooves.

4. The sensor-incorporated wheel support bearing assembly as claimed in claim 2, wherein the force detecting unit is in the form of a coiled winding.

5. The sensor-incorporated wheel support bearing assembly as claimed in claim 4, wherein the coil winding of the force detecting unit is wound around a yoke so as to form a magnetic circuit in an axial direction.

6. The sensor-incorporated wheel support bearing assembly as claimed in claim 5, wherein a surface of the yoke confronting the to-be-detected member is arcuately curved.

7. The sensor-incorporated wheel support bearing assembly as claimed in claim 2, wherein the to-be-detected member includes a plurality of grooves defined therein so as to deploy in a circumferential direction.

8. The sensor-incorporated wheel support bearing assembly as claimed in claim 7, wherein the grooves extend axially.

9. The sensor-incorporated wheel support bearing assembly as claimed in claim 7, wherein the grooves extend having been inclined relative to the axial direction.

10. The sensor-incorporated wheel support bearing assembly as claimed in claim 7, wherein each of the grooves has a depth equal to or greater than 1 mm.

11. The sensor-incorporated wheel support bearing assembly as claimed in claim 7, further comprising a rotation detecting unit utilizing the grooves for detecting a rotation signal.

12. The sensor-incorporated wheel support bearing assembly as claimed in claim 2, wherein the to-be-detected member comprised of the magnetostrictive element is a layer of an Fe—Al alloy formed on a surface region of the inner member.

13. The sensor-incorporated wheel support bearing assembly as claimed in claim 2, wherein the to-be-detected member is made up of a magnetostrictive element formed by shaping a clad steel, of which surface is an Fe—Al alloy, to represent a ring shape and wherein the ring shaped magnetostrictive element is fixed on an outer periphery of the inner member.

14. The sensor-incorporated wheel support bearing assembly as claimed in claim 2, wherein an axial portion of the inner member, where the to-be-detected member is provided, has a rigidity reduced to a value lower than that of any other axial portion of the inner member.

15. The sensor-incorporated wheel support bearing assembly as claimed in claim 14, the rigidity of the axial portion where the to-be-detected member is provided is reduced by defining a thin-walled portion formed by recessing a portion of an inner peripheral surface of the inner member, that is positioned inwardly of the to-be-detected member, or a stepped portion formed by reducing an outer diameter of that axial portion, where the to-be-detected member is provided, down to a value smaller than that of other portions of that axial portion.

16. The sensor-incorporated wheel support bearing assembly as claimed in claim 2, wherein at least one of a surface of the to-be-detected member and a surface of a yoke of the force detecting unit which confronts the to-be-detected member is machined or ground to form a mechanically processed surface for increasing a concentricity or roundness therebetween.

17. The sensor-incorporated wheel support bearing assembly as claimed in claim 2, wherein the force detecting unit comprises at least two force detecting elements and further comprising a circuit for detecting a magnitude of a force and a direction, in which the force acts, in reference to a detection signal outputted from each of the force detecting elements.

18. The sensor-incorporated wheel support bearing assembly as claimed in claim 7, wherein the force detecting unit comprises at least two force detecting elements spaced from each other in a vertical direction and further comprising a circuit for detecting a force caused by a bending moment and an axially acting force separately in reference to the detection signal outputted from each of the force detecting elements.

19. The sensor-incorporated wheel support bearing assembly as claimed in claim 2, further comprising a torque detector for detecting a change in magnetic strain occurring in the to-be-detected member to thereby detect a torque.

20. The sensor-incorporated wheel support bearing assembly as claimed in claim 19, wherein the torque detector includes a generally U-shaped exciting head for exciting the to-be-detected member, and a generally U-shaped detecting head for detecting a change in magnetic strain occurring in the to-be-detected member, the exciting and detecting heads being arranged in a relation perpendicular to each other.

21. The sensor-incorporated wheel support bearing assembly as claimed in claim 19, wherein the torque detector detects the torque by detecting grooves which are formed in the to-be-detected member, comprised of the magnetostrictive element, so as to deploy in a circumferential direction and as to be inclined relative to an axial direction.

22. The sensor-incorporated wheel support bearing assembly as claimed in claim 2, wherein the force detecting unit comprises a yoke made of a magnetic material and having a coil wound therearound, and the coil of the force detecting unit is arranged in a portion of the outer member, confronting the to-be-detected member, in a coaxial relation with the force detecting unit while spaced a predetermined distance from the to-be-detected member and wherein a change in magnetic strain occurring as a result of an axial load in the to-be-detected member is detected by the coil over an entire circumference of the to-be-detected member.

23. The sensor-incorporated wheel support bearing assembly as claimed in claim 2, further comprising a unit for detecting a horizontally acting bending moment from a detection signal output from the force detecting unit, and a unit for detecting a load acting on the wheel support bearing assembly in a direction confronting a running direction, in reference to the horizontally acting bending moment and a center point of support of the wheel support bearing assembly.

24. The sensor-incorporated wheel support bearing assembly as claimed in claim 1, further comprising a signal processing unit for rendering only a peak value of a load signal, obtained from the load sensor, to be a load signal.

25. The sensor-incorporated wheel support bearing assembly as claimed in claim 1, further comprising a unit for canceling an offset of an output from the load sensor with an output from the load sensor during parking or straight run being taken as zero.

26. The sensor-incorporated wheel support bearing assembly as claimed in claim 2, further comprising electrodes disposed within the force detecting unit for drawing signals therefrom, and terminals for contacting or engaging the electrodes of the force detecting unit from outside of the outer member while the force detecting unit is fixedly mounted on the outer member.

27. The sensor-incorporated wheel support bearing assembly as claimed in claim 26, wherein the terminals to be inserted from outside of the outer member are integrated with a connector casing and further comprising a waterproofing rubber bush interposed between the connector casing and the outer member.

28. The sensor-incorporated wheel support bearing assembly as claimed in claim 2, wherein the force detecting unit is divided into a plurality of detecting members and those detecting members are inserted from outside of the outer member and are then fixed in position.

29. The sensor-incorporated wheel support bearing assembly as claimed in claim 1, wherein a load signal obtained from the load sensor is utilized for an attitude control of the automotive body structure.

30. The sensor-incorporated wheel support bearing assembly as claimed in claim 1, further comprising a unit for detecting a condition of a road surface in reference to a frequency of the load signal output from the load sensor.

31. The sensor-incorporated wheel support bearing assembly as claimed in claim 1, further comprising one or both of a rotation sensor and a temperature sensor.

32. The sensor-incorporated wheel support bearing assembly as claimed in claim 1, wherein at least one of supplying an electric power to the load sensor and transmitting a detection signal from the load sensor is carried out wirelessly.

33. The sensor-incorporated wheel support bearing assembly as claimed in claim 2, wherein the inner member comprises,
a hub axle and an inner race segment mounted externally on an inboard end portion of the hub axle and wherein the load sensor comprises a to-be-detected member in the form of a magnetostrictive element provided on a portion of an outer periphery of the hub axle between the inboard end portion thereof and the raceway groove, and
at least one force detecting unit provided in the outer member for detecting change in magnetic strain of the to-be-detected member.

34. The sensor-incorporated wheel support bearing assembly as claimed in claim 2, wherein the hub axle has a cylindrical mounting region where the inner race segment is mounted, the cylindrical mounting region being undersized in diameter relative to the raceway groove 5 and being extended a distance towards an outboard side beyond an axial region where the inner race segment is seated, and further comprising a ring-shaped magnetostrictive member press-fitted onto that portion of the cylindrical mounting region of the hub axle.

35. The sensor-incorporated wheel support bearing assembly as claimed in claim 2, wherein the inner member comprises a hub axle and an inner race segment mounted on an inboard end portion of the hub axle and comprising a load sensor comprising a to-be-detected member, comprised of a magnetostrictive element provided on a portion of an outer periphery of the hub axle between an inboard end portion of the inner race segment and the raceway groove, and at least one force detecting unit provided in the outer member for detecting change in magnetic strain of the to-be-detected member.
